(19) United States
(12) Patent Application Publication
(10) Pub. No.: US 2026/0127887 A1
(43) Pub. Date: May 7, 2026

(54) INFORMATION PROCESSING SYSTEM, INFORMATION PROCESSING APPARATUS, INFORMATION PROCESSING METHOD, AND NON-TRANSITORY COMPUTER-READABLE MEDIUM

(71) Applicant: NEC Corporation, Minato-ku, Tokyo (JP)

(72) Inventors: Takayuki KASE, Tokyo (JP); Jianquan LIU, Tokyo (JP); Tingting DONG, Tokyo (JP); Noboru YOSHIDA, Tokyo (JP)

(73) Assignee: NEC Corporation, Minato-ku, Tokyo (JP)

(21) Appl. No.: 19/117,458

(22) PCT Filed: Oct. 11, 2022
(86) PCT No.: PCT/JP2022/037809

§ 371 Date: Apr. 1, 2025

(51) Int. Cl. G06V 20/52; G06V 10/44; G06V 20/40; G06V 40/10; G06V 40/20

(52) U.S. Cl. CPC G06V 20/53; G06V 10/44; G06V 20/41; G06V 40/10; G06V 40/20

(57) ABSTRACT

An information processing system (100) includes an analysis result acquisition unit (131), a candidate detection unit (132), and a stray detection unit (134). The analysis result acquisition unit (131) acquires an analysis result of videos captured by a plurality of image capture apparatuses (101). The candidate detection unit (132) detects a stray candidate from persons captured in the videos by using person attributes included in the analysis result and a candidate condition. In a case where a companion of the stray candidate exists at a first point in time, the stray detection unit (134) detects a stray from among the stray candidates, based on a comparison result between a companion of the stray candidate at the first point in time and a companion of the stray candidate at a second point in time earlier than the first point in time.

### TECHNICAL FIELD

The present invention relates to an information processing system, an information processing apparatus, an information processing method, and a medium.

### BACKGROUND ART

For example, Patent Document 1 discloses a technology for detecting a stray.

A stray determination unit described in Patent Document 1 particularly extracts only a person of an age to become a possible stray, based on person information.

The person information is a result of performing feature extraction of a contour and/or the like by a feature extraction unit, a person extraction unit, and a personal feature analysis unit from an image of a surveillance camera installed at a certain location, automatically recognizing persons, and performing personal feature analysis on the age, the clothing, the physical constitution, and the like of each person.

In a case where the stray determination unit described in Patent Document 1 determines that a person may be a stray, based on information such as an anxious look or action and whether the person is acting independently (alone), the information being a result of an action analysis on the person performed by an action analysis unit in parallel, the stray determination unit determines that such a person is a stray.

Note that Patent Document 2 describes a technology for computing a feature value of each of a plurality of keypoints of a human body included in an image, searching for an image including a human body with a similar pose or a human body with a similar movement, based on the computed feature values, and grouping together and categorizing the human bodies with similar poses and similar movements.

Non-Patent Document 1 describes a technology related to skeletal estimation of a person.

### RELATED DOCUMENT

### Patent Document

Patent Document 1: Japanese Patent Application Publication No. 2021-108149

Patent Document 2: International Application Publication No. WO 2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields,” The IEEE Conference on Computer Vision and Pattern Recognition (CVPR), 2017, PP. 7291 to 7299

### SUMMARY

### Technical Problem

However, as described above, the technology described in Patent Document 1 detects a stray, based on information such as an anxious look or action and whether a person is acting independently (alone). Therefore, high-precision detection of a stray abducted by a strange third person is difficult.

For example, high-precision detection of a look or an action of a person in an image from the image is generally difficult. Even in a case where detection is possible, high-precision detection of a look or an action of the person in the image may not be possible in a case of poor image quality or the like. Thus, in a case where detection precision of an anxious look or action is low, the technology described in Patent Document 1 may not be able to perform high-precision detection of an abducted stray.

Further, for example, a person of an age to become a possible stray may generally have an anxious look or take an anxious action even in a case of being with a protector. In such a case, the person may be detected as a stray even in the case of being with a protector in the technology described in Patent Document 1.

Further, for example, an abducted stray is likely to act with a strange third person and is not likely to act independently. Therefore, it is difficult to detect an abducted stray by using an independent (alone) action in the technology described in Patent Document 1.

Abduction is highly likely a dangerous situation for a target stray and detection of the abduction is extremely important for safety and the like of the stray.

Note that Patent Document 2 and Non-Patent Document 1 do not disclose a technology for detecting a stray.

An example of an object of the present invention is to, in view of the aforementioned issues, provide an information processing system, an information processing apparatus, an information processing method, and a medium that resolve the issue of ensuring safety of a stray.

### Solution to Problem

According to an aspect of the present invention, an information processing system including:
an analysis result acquisition unit that acquires an analysis result of videos captured by a plurality of image capture units;
a candidate detection unit that detects a stray candidate from one or more persons captured in the video by using one or more person attributes included in the analysis result and a candidate condition; and
a stray detection unit that, in a case where a companion of the stray candidate exists at a first point in time, detects a stray from among the one or more stray candidates, based on a comparison result between a companion of the stray candidate at the first point in time and a companion of the stray candidate at a second point in time earlier than the first point in time is provided.

According to an aspect of the present invention, an information processing method including, by one or more computers:
acquiring an analysis result of videos captured by a plurality of image capture units;
detecting a stray candidate from one or more persons captured in the video by using one or more person attributes included in the analysis result and a candidate condition; and, in a case where a companion of the stray candidate exists at a first point in time, detecting a stray from among the one or more stray candidates, based on a comparison result between a companion of the stray candidate at the first point in time and a companion of the stray candidate at a second point in time earlier than the first point in time is provided.

According to an aspect of the present invention, a medium on which a program is recorded, the program causing one or more computers to execute:
acquiring an analysis result of videos captured by a plurality of image capture units;
detecting a stray candidate from one or more persons captured in the video by using one or more person attributes included in the analysis result and a candidate condition; and,
in a case where a companion of the stray candidate exists at a first point in time, detecting a stray from among the one or more stray candidates, based on a comparison result between a companion of the stray candidate at the first point in time and a companion of the stray candidate at a second point in time earlier than the first point in time is provided.

### Advantageous Effects of Invention

According to the aspects of the present invention, safety of a stray can be ensured.

### BRIEF DESCRIPTION OF THE DRAWINGS

FIG. 1 is a diagram illustrating an overview of an information processing system according to a first example embodiment.

FIG. 2 is a diagram illustrating an overview of an information processing apparatus according to the first example embodiment.

FIG. 3 is a flowchart illustrating an overview of information processing according to the first example embodiment.

FIG. 4 is a diagram illustrating a configuration example of the information processing system.

FIG. 5 is a diagram illustrating a functional configuration example of the information processing apparatus according to the first example embodiment.

FIG. 6 is a diagram illustrating a functional configuration example of a stray detection unit according to the first example embodiment.

FIG. 7 is a diagram illustrating a functional configuration example of a terminal according to the first example embodiment.

FIG. 8 is a diagram illustrating a physical configuration example of an image capture apparatus according to the first example embodiment.

FIG. 9 is a diagram illustrating a physical configuration example of an analysis apparatus according to the first example embodiment.

FIG. 10 is a flowchart illustrating an example of image capture processing according to the first example embodiment.

FIG. 11 is a diagram illustrating an example of a floor map of a target area.

FIG. 12 is a diagram illustrating an example of frame information.

FIG. 13 is a flowchart illustrating an example of analysis processing according to the first example embodiment.

FIG. 14 is a flowchart illustrating an example of stray detection processing according to the first example embodiment.

FIG. 15 is a flowchart illustrating an example of detection processing according to the first example embodiment.

FIG. 16 is a diagram for illustrating comparison processing according to the first example embodiment.

FIG. 17 is a flowchart illustrating an example of display processing according to the first example embodiment.

FIG. 18 is a diagram illustrating a functional configuration example of an information processing apparatus according to a second example embodiment.

FIG. 19 is a flowchart illustrating an example of stray detection processing according to the second example embodiment.

FIG. 20 is a diagram illustrating a functional configuration example of an information processing apparatus according to a third example embodiment.

FIG. 21 is a diagram illustrating a functional configuration example of a stray detection unit according to the third example embodiment.

FIG. 22 is a flowchart illustrating an example of stray detection processing according to the third example embodiment.

FIG. 23 is a flowchart illustrating an example of detection processing according to the third example embodiment.

FIG. 24 is a flowchart illustrating an example of comparison processing according to the third example embodiment.

FIG. 25 is a flowchart illustrating an example of the comparison processing according to the third example embodiment.

### EXAMPLE EMBODIMENT

Example embodiments of the present invention will be described below by using the drawings. Note that in every drawing, similar components are given similar signs, and description thereof is omitted as appropriate.

### First Example Embodiment

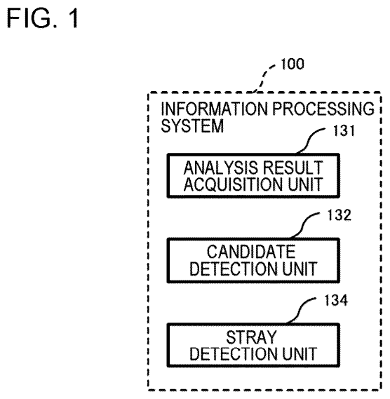

FIG. 1 is a diagram illustrating an overview of an information processing system 100 according to a first example embodiment. The information processing system 100 includes an analysis result acquisition unit 131, a candidate detection unit 132, and a stray detection unit 134.

The analysis result acquisition unit 131 acquires an analysis result of videos captured by a plurality of image capture apparatuses 101.

The candidate detection unit 132 detects a stray candidate from persons captured in videos by using person attributes included in an analysis result and a candidate condition.

In a case where a companion of a stray candidate exists at a first point in time, the stray detection unit 134 detects a stray from stray candidates, based on a comparison result between the companion of the stray candidate at the first point in time and a companion of the stray candidate at a second point in time earlier than the first point in time.

The information processing system 100 can ensure safety of a stray.

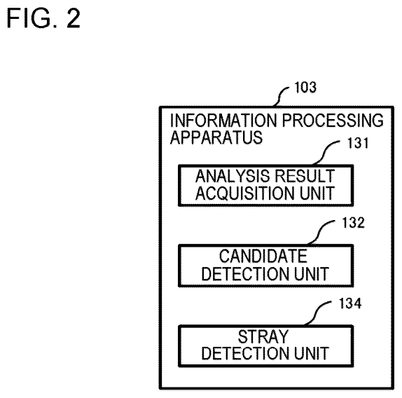

FIG. 2 is a diagram illustrating an overview of an information processing apparatus 103 according to the first example embodiment.

The information processing apparatus 103 includes the analysis result acquisition unit 131, the candidate detection unit 132, and the stray detection unit 134.

The analysis result acquisition unit 131 acquires an analysis result of videos captured by a plurality of image capture apparatuses 101.

The candidate detection unit 132 detects a stray candidate from persons captured in videos by using person attributes included in an analysis result and a candidate condition.

In a case where a companion of a stray candidate exists at a first point in time, the stray detection unit 134 detects a stray from stray candidates, based on a comparison result between the companion of the stray candidate at the first point in time and a companion of the stray candidate at a second point in time earlier than the first point in time.

The information processing apparatus 103 can ensure safety of a stray.

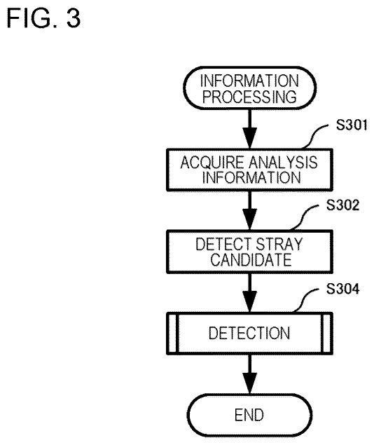

FIG. 3 is a flowchart illustrating an overview of information processing according to the first example embodiment.

The analysis result acquisition unit 131 acquires an analysis result of videos captured by the plurality of image capture apparatuses 101 (Step S301).

The candidate detection unit 132 detects a stray candidate from persons captured in the videos by using person attributes included in the analysis result and a candidate condition (Step S302).

In a case where a companion of a stray candidate exists at a first point in time, the stray detection unit 134 detects a stray from among stray candidates, based on a comparison result between the companion of the stray candidate at the first point in time and a companion of the stray candidate at a second point in time earlier than the first point in time (Step S304).

The information processing can ensure safety of a stray.

A detailed example of the information processing system 100 according to the first example embodiment will be described below.

### Details

### Configuration Example of Information Processing System 100

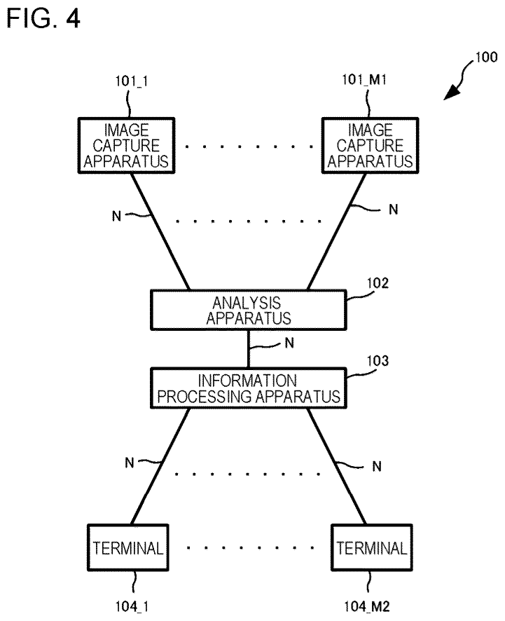

FIG. 4 is a diagram illustrating a configuration example of the information processing system 100.

The information processing system 100 is a system for detecting an abducted stray. An abducted stray is a person abducted by a third person. For example, a third person is a person other than a protector of a stray. A stray is not limited to a child and may be, for example, an aged person.

A target area in which the information processing system 100 detects a stray in the present example embodiment is a shopping mall. Note that a target area has only to be predetermined as appropriate, and examples of the target area may include various facilities or landmarks, part or the whole of a building, and a predetermined area on a public road.

The information processing system 100 includes first to M-th image capture apparatuses 101_1 to 101_M1, an analysis apparatus 102, the information processing apparatus 103, and first to N-th terminals 104_1 to 104_M2.

M1 is an integer equal to or greater than 2. M2 is an integer equal to or greater than 1. Note that M1 may be equal to 1.

Each of the first to M-th image capture apparatuses 101_1 to 101_M1 may be configured similarly. Therefore, any one of the first to M-th image capture apparatuses 101_1 to 101_M1 is also hereinafter expressed as an “image capture apparatus 101.”

Further, each of the terminals 104_1 to 104_M2 may be configured similarly. Therefore, any one of the terminals 104_1 to 104_M2 is also hereinafter expressed as a “terminal 104.”

Each of the plurality of image capture apparatuses 101, the analysis apparatus 102, the information processing apparatus 103, and each of one or a plurality of terminals 104 are connected to each other through a communication network and can transmit and receive information to and from each other through the communication network.

### Functional Configuration Example of Image Capture Apparatus 101

The image capture apparatus 101 generates a video by capturing images of a predetermined image capture region. For example, the video is configured with time-series frame images in which the image capture region is captured. The image capture apparatus 101 transmits the video to the analysis apparatus 102. The image capture region is part or the whole of a target area.

An image capture region is predetermined for each of the first to M-th image capture apparatuses 101_1 to 101_M1. Therefore, a plurality of image capture regions exist in the information processing system 100.

The plurality of image capture regions may be different regions in the target area. For example, the plurality of image capture regions are regions not overlapping each other. Note that the plurality of image capture regions may be regions where part or the whole of a certain target region overlaps with part or the whole of another target region. In a case where the whole image capture regions overlap each other, images of the image capture regions may be captured by image capture apparatuses 101 with different performance related to image capture, such as resolution and lens performance.

### Functional Configuration Example of Analysis Apparatus 102

The analysis apparatus 102 analyzes videos captured by the plurality of image capture apparatuses 101 and generates an analysis result. The analysis apparatus 102 transmits the generated analysis result to the information processing apparatus 103.

The analysis result includes at least person attributes of persons included in the videos. A person attribute is an attribute of a person. Examples of a person attribute may include one or more of an age (including an age group), clothing, a position, a moving direction, a moving velocity, a height, and a gender. Note that a person attribute is not limited to the examples cited above, and detailed examples of a person attribute will be described later.

### Functional Configuration Example of Information Processing Apparatus 103

The information processing apparatus 103 detects an abducted stray by using the analysis result from the analysis apparatus 102.

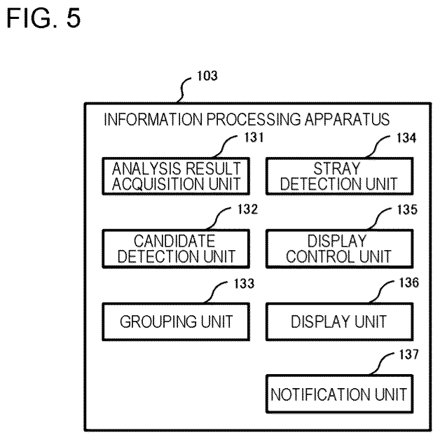

FIG. 5 is a diagram illustrating a functional configuration example of the information processing apparatus 103 according to the first example embodiment. The information processing apparatus 103 includes the analysis result acquisition unit 131, the candidate detection unit 132, a grouping unit 133, the stray detection unit 134, a display control unit 135, a display unit 136, and a notification unit 137.

The analysis result acquisition unit 131 acquires an analysis result of videos captured by the plurality of image capture apparatuses 101 from the analysis apparatus 102. The analysis result acquisition unit 131 may acquire a frame image and/or a video being the basis for generating the analysis result together with the analysis result from the analysis apparatus 102.

“A and/or B” means both A and B or either one of A and B, and the same holds below.

The candidate detection unit 132 detects a stray candidate from persons captured in videos by using person attributes included in an analysis result acquired by the analysis result acquisition unit 131 and a candidate condition.

The candidate condition is a condition related to a stray candidate and, for example, is preset by a user. An attribute of a person who is likely to become a stray is preferably set to the candidate condition. More specifically, for example, the candidate condition includes one or a plurality of conditions related to age, such as 10 years old or younger and 80 years old or older.

The grouping unit 133 determines a group to which persons in a video belong by using person attributes included in an analysis result acquired by the analysis result acquisition unit 131 and a predetermined grouping condition.

The grouping condition is a condition for grouping persons captured in a video by using person attributes included in the analysis result.

More specifically, for example, the grouping condition includes one or a plurality of items out of persons being within a predetermined distance from each other, the difference in moving directions of the persons being within a predetermined range, the difference in moving velocities of the persons being within a predetermined range, and the persons having a conversation with each other.

In a case where a companion of a stray candidate exists at a first point in time, the stray detection unit 134 detects a stray from among stray candidates, based on a comparison result between the companion of the stray candidate at the first point in time and a companion of the stray candidate at a second point in time. Then, the stray detection unit 134 generates stray information related to the detected stray.

The second point in time is a point in time earlier than the first point in time.

The stray information is information about a stray. For example, the stray information includes one or a plurality of items out of one or more person attributes of the stray, an image of the stray, the positions of the stray at the first point in time and the second point in time, a frame image and a video including the stray at the first point in time and the second point in time.

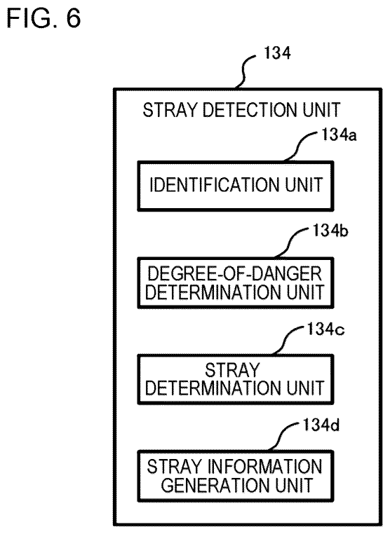

FIG. 6 is a diagram illustrating a functional configuration example of the stray detection unit 134 according to the first example embodiment. The stray detection unit 134 includes an identification unit 134a, a degree-of-danger determination unit 134b, a stray determination unit 134c, and a stray information generation unit 134d.

The identification unit 134a identifies whether a companion of a stray candidate exists at a first point in time.

The degree-of-danger determination unit 134b determines a degree of danger based on the position of a stray candidate at the first point in time.

More specifically, for example, the degree-of-danger determination unit 134b determines a degree of danger of a stray candidate at the first point in time, based on the position of the stray candidate at the first point in time and location-by-location degree-of-danger information.

The location-by-location degree-of-danger information is information in which an attribute for each location in a target area is correlated with a degree of danger and is preferably preset.

In a case where a companion of a stray candidate is identified to exist at the first point in time, the stray determination unit 134c detects a stray from among stray candidates, based on a comparison result between the companion of the stray candidate at the first point in time and a companion of the stray candidate at a second point in time.

For example, the aforementioned “comparison result between companions” may be information indicating whether the companion has changed. Specifically, for example, in a case where a companion of the stray candidate exists at the first point in time, the stray detection unit 134 may detect a stray from among the stray candidates, based on whether the companion of the stray candidate has changed between the first point in time and the second point in time.

Further, whether the companion has changed may be whether all companions of the stray candidate have changed at the first point in time from the second point in time (i.e., whether the stray candidate accompanies only a person different from one at the second point in time).

In general, for example, a child may accompany a protector at a second point in time and join with another protector, an acquaintance of the protector, or the like at a first point in time. By identifying a change in companion with whether all companions of a stray candidate at the first point in time have changed from those at the second point in time as a condition, the possibility of detecting the stray candidate in such a situation as an abducted stray can be prevented. Consequently, a stray who is likely to have been abducted can be detected, and therefore, safety of the stray can be ensured.

Note that whether companions have changed may be whether at least part of the companions at the first point in time have changed from those at the second point in time. Consequently, a stray candidate in the aforementioned situation can be detected as an abducted stray. The stray candidate in the aforementioned situation may also be an abducted stray, and therefore, safety of the stray can be ensured.

There may be various methods for identifying whether a companion of a stray candidate exists at a first point in time. The present example embodiment will be described with an example of using a group determined by the grouping unit 133 in identification of whether a companion of a stray candidate exists at a first point in time.

Specifically, the identification unit 134a according to the present example embodiment identifies whether a companion of a stray candidate exists at a first point in time by using a group to which the stray candidate belongs at the first point in time.

Further, there may be various methods for comparing a companion at a first point in time and a companion at a second point in time. The present example embodiment will be described by using an example of the stray detection unit 134 detecting a stray from among stray candidates by using a group determined by the grouping unit 133.

Specifically, in a case where a companion of a stray candidate exists at a first point in time, the stray detection unit 134 according to the present example embodiment compares the companion of the stray candidate at the first point in time with a companion at a second point in time by using groups to which the stray candidate belongs at the first point in time and at the second point in time, respectively. Then, the stray detection unit 134 detects a stray from among stray candidates, based on the comparison result.

More specifically, for example, in a case where a companion of a stray candidate is identified to exist at the first point in time, the stray determination unit 134c compares a person who belongs to the same group as the stray candidate at the first point in time with a person who belongs to the same group as the stray candidate at the second point in time. Then, the stray determination unit 134c detects a stray from among stray candidates, based on the comparison result. The person who belongs to the same group as the stray candidate corresponds to a companion.

Furthermore, the present example embodiment will be described by using an example of a degree of danger of a stray candidate at a first point in time being referred to for detecting a stray from stray candidates.

Specifically, in a case where a companion of a stray candidate exists at a first point in time, the stray detection unit 134 (more specifically, the stray determination unit 134c) according to the present example embodiment detects a stray from among stray candidates, based on the aforementioned comparison result and a degree of danger based on the position of the stray candidate at the first point in time.

Note that the degree of danger of the stray candidate at the first point in time may not be referred to for detecting a stray from the stray candidates.

The stray information generation unit 134d generates stray information related to a stray detected by the stray determination unit 134c.

More specifically, for example, the stray information generation unit 134d preferably generates stray information including part or the whole of an analysis result related to a stray in an analysis result acquired by the analysis result acquisition unit 131. The stray information generation unit 134d may generate stray information further including a frame image and/or a video. The frame image and/or the video may be a frame image and/or a video in which the stray is captured or may be the basis for generating the analysis result included in the stray information. The stray information generation unit 134d may generate stray information further including a degree of danger determined for the stray included in the stray information.

FIG. 5 is referred to again.

The display control unit 135 causes the display unit 136 to display various types of information. For example, the display unit 136 is a display configured with a liquid crystal panel, an organic electro-luminescence (EL) panel, or the like to be described later.

For example, the display control unit 135 may cause the display unit 136 to display stray information generated by the stray detection unit 134 (more specifically, the stray information generation unit 134d).

For example, the display control unit 135 may cause the display unit 136 to display an image and/or a video acquired by superposing the position of a stray at a first point in time on at least one of a frame image and a video that include the stray at the first point in time. For example, the display control unit 135 may cause the display unit 136 to display an image and/or a video acquired by superposing the position of a stray at a second point in time on at least one of a frame image and a video that include the stray at the second point in time.

For example, in a case where a plurality of strays are detected by the stray detection unit 134, the display control unit 135 may cause the display unit 136 to display pieces of stray information of the plurality of strays in descending order of degree of danger at a first point in time.

Such a display control unit 135 and such a display unit 136 are examples of a display control unit and a display unit, respectively.

The notification unit 137 transmits stray information generated by the stray detection unit 134 (more specifically, the stray information generation unit 134d) to each of one or a plurality of terminals 104.

### Functional Configuration Example of Terminal 104

The terminal 104 is an apparatus for displaying stray information. For example, the terminal 104 is carried by a predetermined person such as a person concerned in a target area. Examples of a person concerned in a target area may include an employee and a guard in the target area.

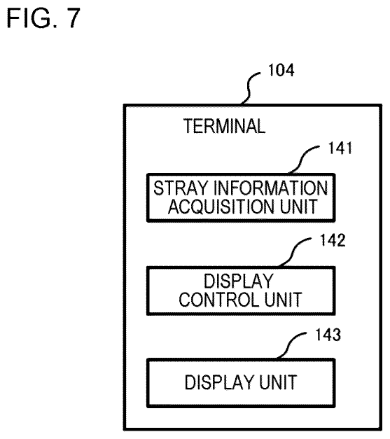

FIG. 7 is a diagram illustrating a functional configuration example of the terminal 104 according to the first example embodiment. The terminal 104 includes a stray information acquisition unit 141, a display control unit 142, and a display unit 143.

The stray information acquisition unit 141 acquires stray information from the information processing apparatus 103.

The display control unit 142 causes the display unit 143 to display various types of information. For example, the display unit 143 is a display configured with a liquid crystal panel, an organic electro-luminescence (EL) panel, or the like to be described later.

For example, the display control unit 142 causes the display unit 143 to display stray information acquired by the stray information acquisition unit 141.

Such a display control unit 142 and such a display unit 143 are other examples of the display control unit and the display unit, respectively.

### Physical Configuration Example of Information Processing System 100

For example, the information processing system 100 physically includes the first to M-th image capture apparatuses 101_1 to 101_M1, the analysis apparatus 102, the information processing apparatus 103, and the first to N-th terminals 104 1 to 104 M2.

Each of the first to M-th image capture apparatuses 101_1 to 101_M1 may be physically configured similarly. Each of the first to N-th terminals 104_1 to 104_M2 may be physically configured similarly.

Note that the physical configuration of the information processing system 100 is not limited to the above. For example, the functions provided by the plurality of image capture apparatuses 101, the analysis apparatus 102, and the information processing apparatus 103 that are described in the present example embodiment may be physically provided in one apparatus or may be distributed across a plurality of apparatuses in a manner different from the present example embodiment. The function of transmitting or receiving information between the apparatuses 101 to 104 according to the present example embodiment through a network N may transmit or acquire information through an internal bus or the like in place of the network N when the apparatuses are physically built into a common apparatus.

### Physical Configuration Example of Image Capture Apparatus 101

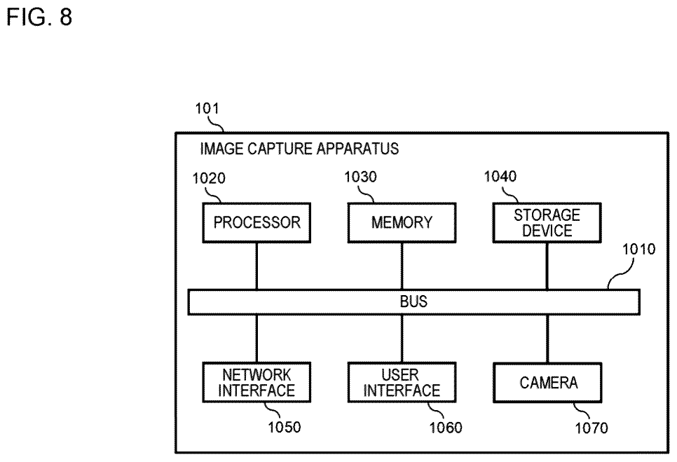

FIG. 8 is a diagram illustrating a physical configuration example of the image capture apparatus 101 according to the first example embodiment. For example, the image capture apparatus 101 physically includes a bus 1010, a processor 1020, a memory 1030, a storage device 1040, a network interface 1050, a user interface 1060, and a camera 1070.

The bus 1010 is a data transmission channel for the processor 1020, the memory 1030, the storage device 1040, the user interface 1050, the network interface 1060, the camera 1070, and a microphone 1080 to transmit and receive data to and from each other. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk drive (HDD), a solid-state drive (SSD), a memory card, a read-only memory (ROM), or the like. The storage device 1040 stores program modules for providing functions of the image capture apparatus 101. By reading each program module into the memory 1030 and executing the program module by the processor 1020, each function related to the program module is provided.

The network interface 1050 is an interface for connecting the image capture apparatus 101 to the network N.

Examples of the user interface 1060 include a touch panel, a keyboard, and a mouse as interfaces for a user to input information, and a liquid crystal panel and an organic electro-luminescence (EL) panel as interfaces for providing information to a user.

The camera 1070 includes an optical system such as an image pickup device and a lens and captures an image of an image capture region under the control of the processor 1020.

Note that the image capture apparatus 101 may accept an input from a user through an external apparatus connected to the network N (e.g., the analysis apparatus 102 or the information processing apparatus 103) and may provide information to the user. In this case, the image capture apparatus 101 may not include the user interface 1050.

### Physical Configuration Example of Analysis Apparatus 102, Information Processing Apparatus 103, and Terminal 104

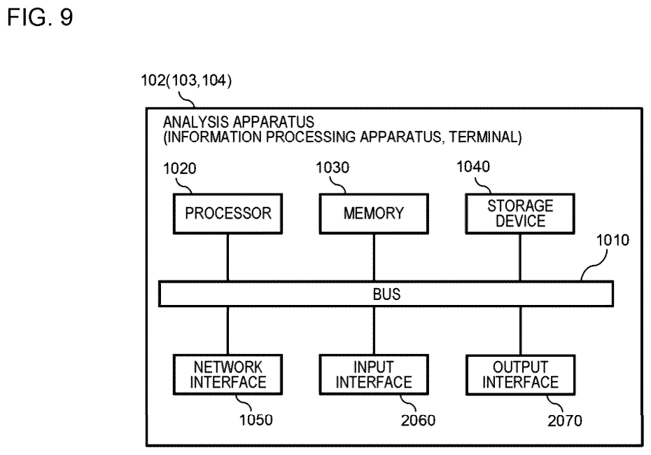

FIG. 9 is a diagram illustrating a physical configuration example of the analysis apparatus 102 according to the first example embodiment. For example, the analysis apparatus 102 physically includes a bus 1010, a processor 1020, a memory 1030, a storage device 1040, and a network interface 1050 that are similar to those in the image capture apparatus 101. For example, the analysis apparatus 102 physically further includes an input interface 2060 and an output interface 2070.

Note that the storage device 1040 in the analysis apparatus 102 stores program modules for providing the functions of the analysis apparatus 102. Further, the network interface 1050 in the analysis apparatus 102 is an interface for connecting the analysis apparatus 102 to the network N.

The input interface 2060 is an interface for a user to input information, examples of the interface including a touch panel, a keyboard, and a mouse. The output interface 2070 is an interface for providing information to a user, as examples of the interface including a liquid crystal panel and an organic EL panel.

For example, it is preferable that each of the information processing apparatus 103 and the terminal 104 according to the first example embodiment be physically configured similarly to the analysis apparatus 102. Note that the storage device 1040 in each of the information processing apparatus 103 and the terminal 104 stores a program module for providing the function of the apparatus/terminal. Further, the network interface 1050 in each of the information processing apparatus 103 and the terminal 104 is an interface for connecting the apparatus/terminal to the network N.

The configuration example of the information processing system 100 according to the first example embodiment has been described above. From here on, an operation example of the information processing system 100 according to the first example embodiment will be described.

### Operation Example of Information Processing System 100

The information processing system 100 according to the present example embodiment executes information processing for detecting an abducted stray. For example, the information processing includes image capture processing, analysis processing, stray detection processing, and display processing.

### Example of Image Capture Processing According to First Example Embodiment

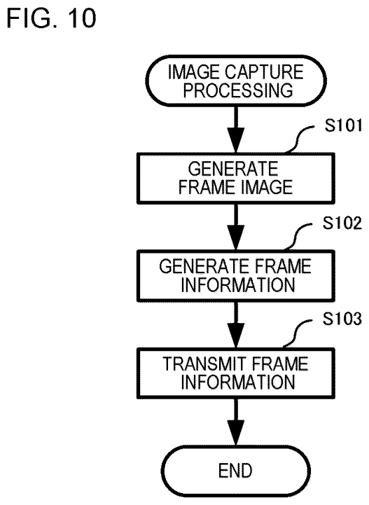

FIG. 10 is a flowchart illustrating an example of the image capture processing according to the first example embodiment. The image capture processing is processing for capturing an image of a target area. For example, upon accepting a start instruction provided by a user from the information processing apparatus 103 through the network N, the image capture apparatus 101 repeatedly executes the image capture processing at a predetermined frame rate until accepting an end instruction provided by the user. Note that the method for starting or ending the image capture processing is not limited to the above.

The frame rate may be determined as appropriate and, for example, is 1/30 seconds or 1/60 seconds.

The image capture apparatus 101 captures an image of an image capture region and generates a frame image in which the image capture region is captured (Step S101).

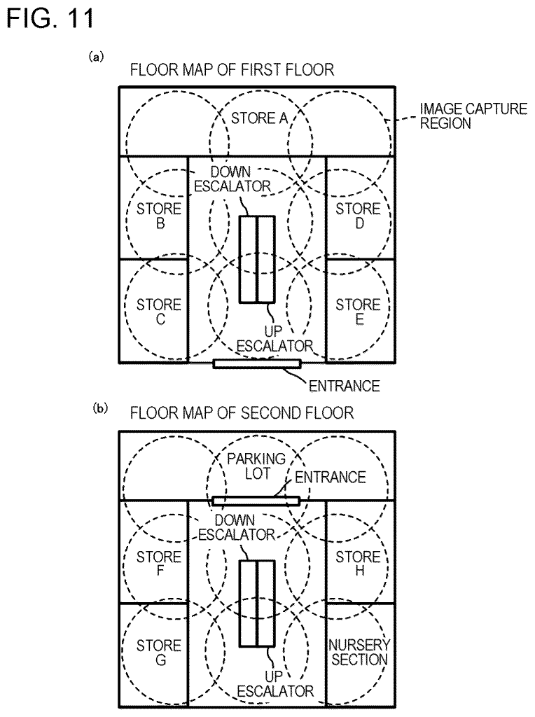

FIG. 11 is a diagram illustrating an example of a floor map of a target area. The target area illustrated in FIG. 11 includes two floors, and FIG. 11 (a) is a diagram illustrating a floor map of the first floor of the target area. FIG. 11 (b) is a diagram illustrating a floor map of the second floor of the target area. A region enclosed by a dotted circle in FIG. 11 indicates an image capture region of each image capture apparatus 101. Since there are 18 image capture regions in the example in FIG. 11, the example is an example of M1 being 18, in other words, an example of the information processing system 100 including 18 image capture apparatuses 101.

Note that one image capture apparatus 101 may be configured to be able to capture images of a plurality of image capture regions.

FIG. 10 is referred to again.

The image capture apparatus 101 generates frame information including the frame image generated in Step S101 (Step S102).

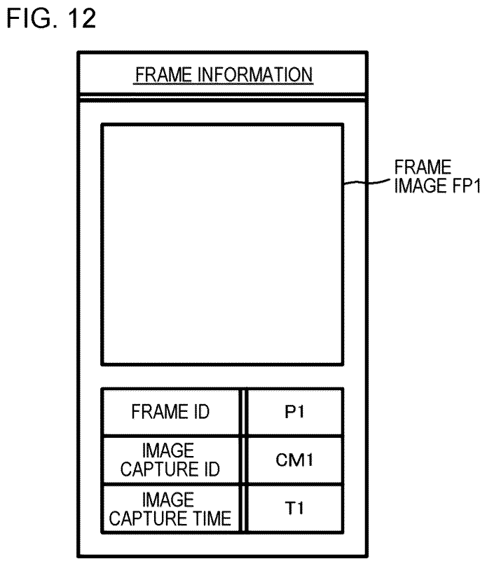

FIG. 12 is a diagram illustrating an example of frame information. For example, frame information is information in which a frame image is associated with a frame identification (ID), an image capture ID, and an image capture time.

A frame ID is information for identifying a frame ID. An image capture ID is information for identifying an image capture apparatus 101. An image capture time is information indicating a time at which image capture is performed. For example, an image capture time includes a date and a time. The time may be represented in predetermined steps such as 1/10 seconds, 1/100 seconds, or the like.

FIG. 12 illustrates that a frame image FP1 with a frame ID “P1” is captured by an image capture apparatus 101 with an image capture ID “CM1” at an image capture time “T1.”

Note that the structure of frame information is not limited to the above.

FIG. 10 is referred to again.

The image capture apparatus 101 transmits the frame information generated in Step S102 to the analysis apparatus 102 (Step S103) and ends the image capture processing.

By each image capture apparatus 101 repeatedly executing such image capture processing, a video in which the target area is captured can be generated and be transmitted to the analysis apparatus 102. The image capture processing is preferably executed in real time.

### Example of Analysis Processing According to First Example Embodiment

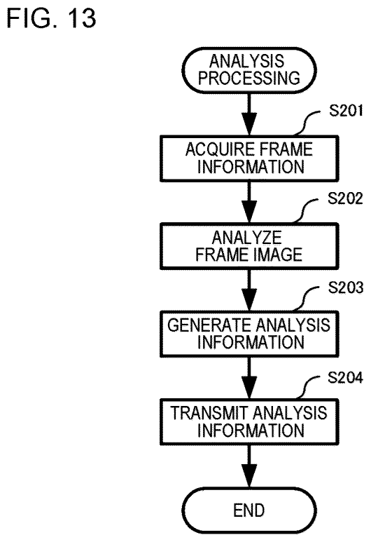

FIG. 13 is a flowchart illustrating an example of the analysis processing according to the first example embodiment. The analysis processing is processing for analyzing a video captured by the image capture apparatus 101. For example, upon accepting a start instruction provided by a user from the information processing apparatus 103 through the network N, the analysis apparatus 102 repeatedly executes the analysis processing until accepting an end instruction provided by the user. Note that the method for starting or ending the analysis processing is not limited to the above.

The analysis apparatus 102 acquires, from the image capture apparatus 101, the frame information transmitted in Step S103 (Step S201).

The analysis apparatus 102 stores the frame information acquired in Step S201 and analyzes a frame image included in the frame information (Step S202).

In the analysis, the analysis apparatus 102 may refer to one or a plurality of items including a frame image captured by another image capture apparatus 101 at the same time, and a past frame image and/or a past analysis result as appropriate.

The another image capture apparatus 101 is an image capture apparatus 101 different from the image capture apparatus 101 generating the frame image being a target of the analysis. Further, the past frame image and/or the past analysis result is a frame image generated by each of the plurality of image capture apparatuses 101 prior to the frame image being the target of the analysis and/or an analysis result of the frame image.

More specifically, for example, the analysis apparatus 102 is provided with one or a plurality of analysis functions for analyzing a video. The analysis functions provided in the analysis apparatus 102 include one or a plurality of (1) an object detection function, (2) a face analysis function, (3) a human type analysis function, (4) a pose analysis function, (5) an action analysis function, (6) an exterior attribute analysis function, (7) a gradient feature analysis function, (8) a color feature analysis function, and (9) a flow line analysis function.
(1) The object detection function detects an object from a frame image. The object detection function can also find the position of the object in the frame image. For example, a technology such as You Only Look Once (YOLO) can be applied to the object detection function. An “object” herein includes a person and a thing, and the same holds below.

Specifically, for example, the object detection function detects a person and a thing in an image capture region captured in a frame image. Further, for example, the object detection function finds the positions of the person and the thing.
(2) The face analysis function detects a face of a person from a frame image and performs extraction of a feature value of the detected face (a facial feature value), categorization (classification) of the detected face, and the like. The face analysis function can also find the position of the face in the image. The face analysis function can also determine identity of persons detected from different frame images, based on a degree of similarity between the facial feature values of the persons detected from the different images, and the like.
(3) The human type analysis function performs extraction of human-body feature values (e.g., values indicating overall features such as a thickness of a body shape, a height, and clothing) of a person included in a frame image, categorization (classification) of the person included in the frame image, and the like. The human type analysis function can also determine the position of the person in the image. The human type analysis function can also determine identity of persons included in different images, based on the human-body feature values of the persons included in the different images, and the like.
(4) The pose analysis function detects joints of a person from an image and creates a stick figure model connecting the joints. Then, the pose analysis function estimates the pose of the person by using information in the stick figure model and performs extraction of a feature value of the estimated pose (a pose feature value), categorization (classification) of the person included in the image, and the like. The pose analysis function can also determine identity of persons included in different images, based on the pose feature values of the persons included in the different images, and the like.

For example, the pose analysis function estimates poses such as a standing pose, a squatting pose, and a stooping pose from an image and extracts a pose feature value indicating each pose.

For example, the technologies disclosed in Patent Document 2 and Non-Patent Document 1 can be applied to the pose analysis function.
(5) The action analysis function can estimate a movement of a person by using information in a stick figure model, a change in a pose, and the like and perform extraction of a feature value of the movement of the person (a movement feature value), categorization (classification) of the person included in an image, and the like. The action analysis processing can also estimate the height of the person by using the information in the stick figure model and determine the position of the person in the image. For example, the action analysis processing can estimate an action such as a change or transition of a pose, a movement (a change or transition of a position), a moving velocity, or a moving direction from an image and extract the movement feature value of the action.
(6) The exterior attribute analysis function can recognize an exterior attribute accompanying a person. The exterior attribute analysis function performs extraction of a feature value related to the recognized exterior attribute (an exterior attribute feature value), categorization (classification) of the person included in an image, and the like. An exterior attribute is an attribute in appearance and, for example, includes one or more of an age (including an age group), a gender, the color of clothing, a hair style, existence of a wearing article, the color of a wearing article when the wearing article is worn. Clothing includes one or more items out of clothes, shoes, and the like. A wearing article includes one or more items out of headwear, a necktie, glasses, a necklace, a ring, and the like.
(7) The gradient feature analysis function extracts a feature value of a gradient in a frame image (a gradient feature value). For example, technologies such as SIFT, SURF, RIFF, ORB, BRISK, CARD, and HOG can be applied to the gradient feature detect function.
(8) The color feature analysis function can detect an object from a frame image and perform extraction of a feature value of the color of the detected object (a color feature value), categorization (classification) of the detected object, and the like.

For example, a color feature value is a color histogram. For example, the color feature analysis function can detect a person and a thing that are included in a frame image. Further, for example, the color feature analysis function can categorize articles into predetermined classes.
(9) For example, the flow line analysis function can find a flow line (a trajectory of movement) of a person included in a video by using a result of identity determination in one of the aforementioned analysis functions (2) to (6). More specifically, for example, by connecting persons determined to be identical between chronologically different frame images, a flow line and the like of the person can be found. Note that the flow line analysis function can also find a flow line extending over a plurality of videos in which different image capture regions are captured.

For example, a person attribute includes at least one of elements included in a detection result of a person in the object detection function, a facial feature value, a human-body feature value, a pose feature value, a movement feature value, an exterior attribute feature value, a gradient feature value, a color feature value, a flow line, a moving velocity, a moving direction, and the like.

Note that each of the analysis functions (1) to (9) may utilize a result of an analysis performed by another analysis function as appropriate.

The analysis apparatus 102 analyzes a video including a frame image by using one or a plurality of such analysis functions and generates a detection result including a person attribute. Each person captured in the frame image is preferably associated with the person attribute of the person in the detection result.

The analysis apparatus 102 generates analysis information in which the analysis result in Step S202 is associated with the frame information acquired in Step S201 (Step S203).

The frame information acquired in Step S201 is frame information including a frame image being the basis for generating the analysis result (i.e., a frame image being the target of the analysis in Step S202).

The analysis apparatus 102 transmits the analysis information generated in Step S203 to the information processing apparatus 103 (Step S204).

It is preferable that such analysis processing be repeatedly executed for each of a plurality of frame images generated by each of the plurality of image capture apparatuses 101. Consequently, a video in which a target area is captured can be analyzed, and an analysis result generated based on the analysis can be transmitted to the information processing apparatus 103.

Note that the analysis apparatus 102 may analyze part of time-series frame images generated by each of the plurality of image capture apparatuses 101 by, for example, executing the analysis processing on frame images at predetermined time intervals. The time interval is preferably set to such a time length that does not affect detection a stray, such as 1 second. Consequently, the number of frame images on which the analysis apparatus 102 performs the analysis processing can be reduced while degradation in precision of stray detection is suppressed, compared with the case of analyzing all time-series frame images. Therefore, the processing load of the analysis apparatus 102 can be lightened while degradation in precision of stray detection is suppressed.

Further, the analysis method executed by the analysis apparatus 102 is not limited to that described above and may be changed as appropriate. For example, the analysis function provided in the analysis apparatus 102 may be changed as appropriate.

### Example of Stray Detection Processing According to First Example Embodiment

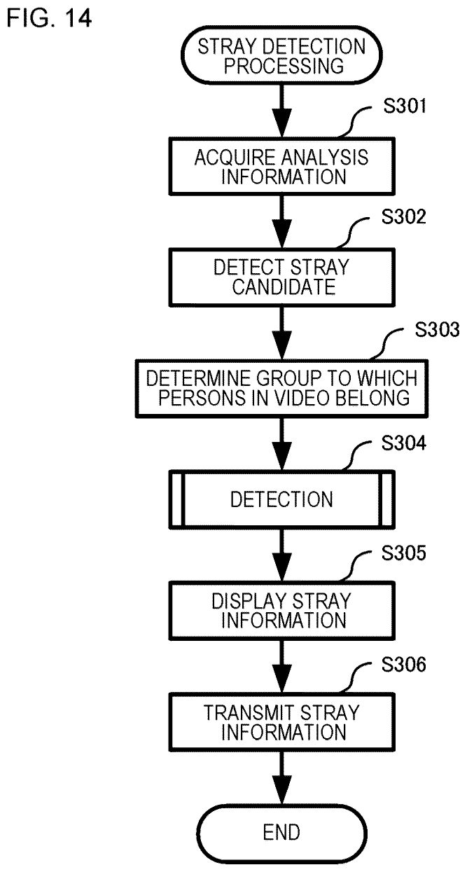

FIG. 14 is a flowchart illustrating an example of the stray detection processing according to the first example embodiment. The stray detection processing is processing for detecting an abducted stray by using an analysis result generated by executing the analysis processing.

For example, upon accepting a start instruction provided by a user, the information processing apparatus 103 transmits a start instruction to the image capture apparatus 101 and the analysis apparatus 102 and starts the stray detection processing. Then, for example, upon accepting an end instruction provided by the user, the information processing apparatus 103 transmits an end instruction to the image capture apparatus 101 and the analysis apparatus 102 and ends the stray detection processing. Specifically, for example, upon accepting a start instruction provided by a user, the information processing apparatus 103 repeatedly executes the stray detection processing until accepting an end instruction provided by the user. Note that the method for starting or ending the stray detection processing is not limited to the above.

The analysis result acquisition unit 131 acquires, from the information processing apparatus 103, the analysis information transmitted in Step S204 (Step S301). Consequently, the analysis result acquisition unit 131 acquires an analysis result and a frame image from the analysis apparatus 102.

By using person attributes included in the analysis result acquired in Step S301 and a candidate condition, the candidate detection unit 132 detects a stray candidate from persons included in the analysis result (Step S302).

More specifically, for example, the candidate detection unit 132 detects, as a stray candidate, a person associated with a person attribute satisfying the candidate condition out of the respective person attributes of persons included in the analysis result acquired in Step S301. For example, in a case where the candidate condition is 10 years old or younger, the candidate detection unit 132 detects a person associated with a person attribute including an age of 10 years old or younger as a stray candidate.

The grouping unit 133 determines a group to which a person in the frame image acquired in Step S301 belongs by using a person attribute included in the analysis result acquired in Step S301 and a predetermined grouping condition (Step S303).

More specifically, for example, for persons included in the analysis result acquired in Step S301, the grouping unit 133 detects and groups a plurality of persons associated with person attributes satisfying the grouping condition. Consequently, the grouping unit 133 determines a group to which the plurality of persons satisfying the grouping condition belong. The group includes a plurality of persons accompanying each other.

Further, for example, as for a person for whom a person associated with a person attribute satisfying the grouping condition does not exist out of the persons included in the analysis result acquired in Step S301, the grouping unit 133 only groups the person. Consequently, the grouping unit 133 determines a group to which a person for whom another person satisfying the grouping condition does not exist belongs. The group includes a single person acting independently.

For example, the grouping unit 133 may store the result of grouping in Step 303, that is, the persons in the frame image and a group to which each person belongs.

In a case where a companion of a stray candidate exists at a first point in time, the stray detection unit 134 detects a stray from among the stray candidates detected in Step S302, based on a comparison result between the companion of the stray candidate at the first point in time and a companion of the stray candidate at a second point in time (Step S304).

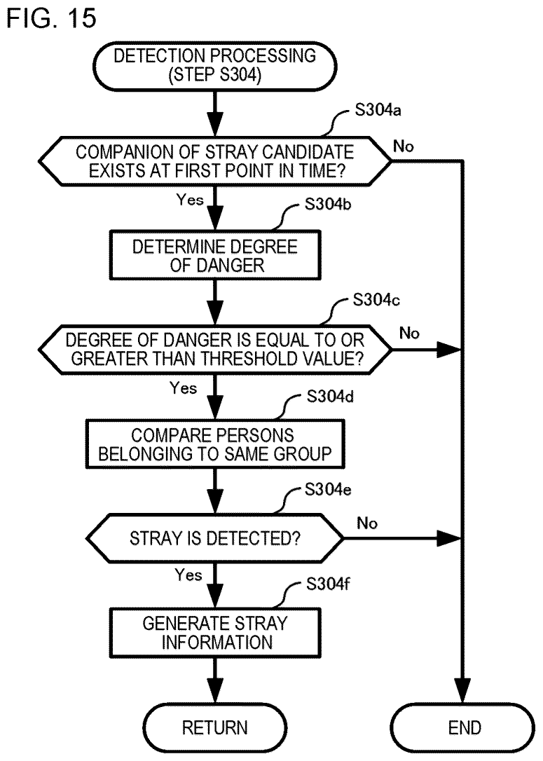

FIG. 15 is a flowchart illustrating an example of detection processing (Step S304) according to the first example embodiment. In a case where there are a plurality of stray candidates detected in Step S302, the stray detection unit 134 preferably executes the detection processing (Step S304) on each stray candidate.

The identification unit 134a identifies whether a companion of a stray candidate exists at the first point in time (Step S304a).

More specifically, for example, the first point in time is the present. In this case, for a stray candidate detected in Step S302, the identification unit 134a identifies whether a person other than the stray candidate is included in the group determined in Step S303. Consequently, the identification unit 134a identifies whether another person belonging to the same group as the stray candidate (i.e., a companion) exists at the first point in time.

In a case where a companion is identified not to exist (Step S304a: No), the identification unit 134a ends the stray detection processing.

In a case where a companion is identified to exist (Step S304a: Yes), the degree-of-danger determination unit 134b determines a degree of danger based on the position of the stray candidate identified to have the companion at the first point in time (Step S304b).

More specifically, for example, the degree-of-danger determination unit 134b acquires the position of the stray candidate identified to have the companion in Step S304a at the first point in time, based on the analysis result acquired in Step S301. The degree-of-danger determination unit 134b determines a degree of danger based on the position of the stray candidate at the first point in time, based on the location-by-location degree-of-danger information.

As described above, the location-by-location degree-of-danger information is information in which an attribute for each location in the target area is correlated with a degree of danger. A degree of danger is an indicator indicating a degree of danger to a stray.

For example, an attribute for each location is at least one of a parking lot, a store, and a nursery section. For example, location-by-location degree-of-danger information in this case includes degrees of danger “high,” “medium,” and “low” as degrees of danger respectively correlated with a parking lot, a store, and a nursery section. Specifically, a parking lot is often deserted to some extent and therefore is correlated with the degree of danger “high.” A store is less deserted compared with a parking lot and therefore is correlated with the degree of danger “medium.” A nursery section is highly likely to be safe and therefore is correlated with the degree of danger “low.”

Note that the location-by-location degree-of-danger information is not limited to the above.

For example, the degree-of-danger determination unit 134b acquires an attribute of a location to which the position of a stray candidate at the first point in time belongs, based on layout information.

The layout information is information indicating a layout of a target area (i.e., locations images of which are captured by the plurality of image capture apparatuses 101). For example, the layout information may include a floor map as a layout. The layout information preferably includes at least one item out of boundaries of an aisle in the target area, the position of a predetermined section such as each store, boundaries of the predetermined section such as each store, the position of an escalator, and the position of an elevator.

Then, the degree-of-danger determination unit 134b acquires a degree of danger correlated with the acquired attribute of the location from the location-by-location degree-of-danger information. Consequently, the degree-of-danger determination unit 134b determines a degree of danger based on the position of the stray candidate identified to have a companion at the first point in time.

The stray determination unit 134c identifies whether the degree of danger determined in Step S304b is equal to or greater than a threshold value (Step S304c). The threshold value is preferably predetermined.

More specifically, for example, the threshold value is assumed to be “medium.” In a case where the location-by-location degree-of-danger information has the aforementioned content, the stray determination unit 134c identifies the degree of danger of a stray candidate who is in the “parking lot” or the “store” at the first point in time to be equal to or greater than the threshold value. Further, the stray determination unit 134c identifies the degree of danger of a stray candidate who is in the “nursery section” at the first point in time to be not equal to or greater than the threshold value.

In a case where the degree of danger is identified to be not equal to or greater than the threshold value (Step S304c: No), the stray determination unit 134c ends the stray detection processing. Consequently, a stray candidate being at a less dangerous location, that is, a safe location is not detected as a stray.

In a case where the degree of danger is identified to be equal to or greater than the threshold value (Step S304c: Yes), the stray determination unit 134c compares a person belonging to the same group as the stray candidate at the first point in time with a person belonging to the same group as the stray candidate at the second point in time (Step S304d).

More specifically, for example, the second point in time is a time of entry into a shopping mall being the target area (a time of entry into a store). For example, the first point in time is the present as described above. In this case, the stray determination unit 134c compares a person belonging to the same group as the stray candidate at the time of entry into the store with a person belonging to the same group as the stray candidate at the present.

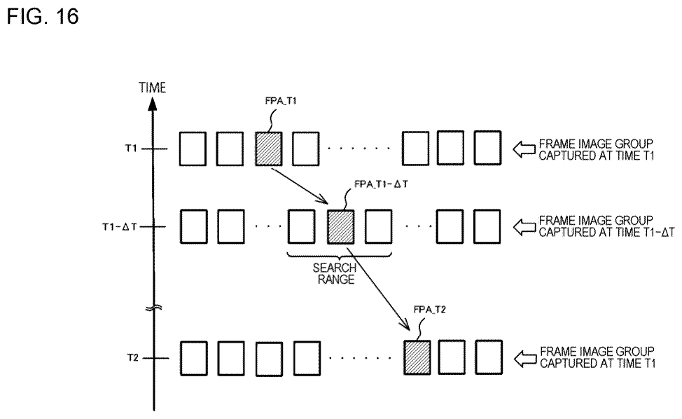

FIG. 16 is a diagram for illustrating comparison processing (Step S304d) between a companion at the first point in time and a companion at the second point in time.

For example, it is assumed that a stray candidate LC is captured in the current frame image FPA_T1 acquired in Step S301. It is assumed that the stray candidate LC has a companion and has a degree of danger equal to or greater than “medium.”

The stray determination unit 134c preferably acquires a person attribute of a person belonging to the same group as the stray candidate LC by referring to a group of each person captured in the frame image acquired in Step S301. Consequently, the stray determination unit 134c can acquire the person attribute of the current companion of the stray candidate LC.

The stray determination unit 134c goes back a predetermined time interval ΔT from the present to the past and determines a frame image in which the stray candidate LC is captured, based on a person attribute acquired in analysis of each frame image.

For example, in a case where a plurality of frame images at an image capture time T1-ΔT is searched for a frame image FPA_T1-ΔT in which the stray candidate LC is captured, it is preferable that the stray determination unit 134c sequentially perform a search from a frame image the image capture region of which is close to (e.g., adjacent to) that of a frame image in which the stray candidate LC at the time T is captured. FIG. 16 illustrates an example of a search range required for determining the frame image FPA_T1-ΔT in which the stray candidate LC is captured is three frame images.

By executing such a search by going back the predetermined time interval ΔT at a time, the stray determination unit 134c determines a frame image in which the stray candidate LC is first captured, that is, a frame image FPA_T2 at the time of entry into the store.

For example, the grouping unit 133 preferably stores a result of grouping based on an analysis result for the frame image FPA_T2 at the time of entry into the store. Note that the grouping unit 133 may determine a group to which each person belongs, based on the analysis result for the frame image FPA_T2 at the time of entry into the store.

The stray determination unit 134c preferably acquires a person attribute of a person belonging to the same group as the stray candidate LC at the time of entry into the store by referring to a group determined for the frame image FPA_T2 at the time of entry into the store. Consequently, the stray determination unit 134c can acquire a person attribute of the companion of the stray candidate LC at the time of entry into the store.

For example, the stray determination unit 134c preferably compares a person attribute of the companion of the stray candidate LC at present with a person attribute of the companion of the stray candidate LC at the time of entry into the store. Consequently, a person belonging to the same group as the stray candidate at present can be compared with a person belonging to the same group as the stray candidate at the time of entry into the store.

FIG. 15 is referred to again.

The stray determination unit 134c determines whether a stray is detected from among the stray candidates, based on the comparison result in Step S304d (Step S304e).

More specifically, for example, based on the person attribute of the companion of the stray candidate LC at present and the person attribute of the companion of the stray candidate LC at the time of entry into the store, the stray determination unit 134c identifies whether one companion common to the points in time exists.

For example, the stray determination unit 134c determines not to detect a stray (i.e., determines that a stray does not exist) in a case where one or more common companions exist between the points in time.

Further, for example, the stray determination unit 134c determines that an abducted stray exists in a case where no companion common to the points in time exists. In other words, in this case, the stray determination unit 134c detects a stray from the stray candidates.

In a case where no stray is detected (Step S304e: No), the stray information generation unit 134d ends the stray detection processing. In a case where a stray is detected (Step S304e: Yes), the stray information generation unit 134d generates stray information related to the stray (Step S304f) and returns to the stray detection processing.

FIG. 14 is referred to again.

The display control unit 135 causes the display unit 136 to display the stray information generated in Step S304f (Step S305).

More specifically, for example, in a case where a plurality of strays are detected in Step S304e, the display control unit 135 causes the display unit 136 to display pieces of stray information generated for the plurality of strays in Step S304f in descending order of degree of danger determined in Step S304b.

The notification unit 137 transmits the stray information generated in Step S304f to each of one or a plurality of terminals 104 (Step S306).

It is preferable that such stray detection processing be repeatedly executed every time analysis information transmitted in the analysis processing is acquired. Consequently, an abducted stray can be detected. Further, stray information related to the detected stray can be displayed on the display unit 136, and a user can easily notice the abducted stray.

### Example of Display Processing According to First Example Embodiment

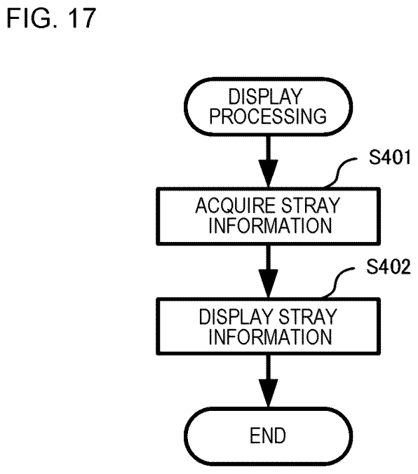

FIG. 17 is a flowchart illustrating an example of display processing according to the first example embodiment. The display processing is processing for causing the terminal 104 to display stray information transmitted by executing the stray detection processing. In a case where there are a plurality of terminals 104, each terminal 104 preferably executes the display processing.

For example, upon a launch of preinstalled software, the terminal 104 starts the display processing. For example, the terminal 104 executes the display processing during operation of the software. Note that the method for starting or ending the display processing is not limited to the above.

The stray information acquisition unit 141 acquires, from the information processing apparatus 103, the stray information transmitted in Step S137 (Step S401).

The display control unit 142 causes the display unit 143 to display the stray information acquired in Step S401 (Step S402) and ends the display processing.

More specifically, for example, in a case where stray information for a plurality of strays is acquired in Step S401, for example, the display control unit 142 causes the display unit 143 to display pieces of stray information in descending order of degree of danger of each stray included in the stray information. For example, upon acceptance of a predetermined operation for closing a display screen of the stray information by the terminal 104, the display control unit 142 preferably ends the display processing.

By execution of such display processing, a person carrying the terminal 104 can promptly notice an abducted stray and go to the rescue of the stray.

### Advantageous Effect

As described above, the information processing system 100 according to the first example embodiment includes the analysis result acquisition unit 131, the candidate detection unit 132, and the stray detection unit 134.

The analysis result acquisition unit 131 acquires an analysis result of videos captured by the plurality of image capture apparatuses 101. The candidate detection unit 132 detects a stray candidate from persons captured in the videos by using person attributes included in the analysis result and the candidate condition. In a case where a companion of a stray candidate exists at a first point in time, the stray detection unit 134 detects a stray from stray candidates, based on a comparison result between the companion of the stray candidate at the first point in time and a companion of the stray candidate at a second point in time earlier than the first point in time.

Thus, a stray is detected from among stray candidates each having a companion at the first point in time. A stray having a companion at the first point in time is highly likely to be an abducted stray; and since such a stray can be automatically detected, an abducted stray can be promptly detected and measures such as rescue of the stray can be taken. Accordingly, safety of the stray can be ensured.

According to the first example embodiment, the candidate condition includes a condition related to age.

Consequently, since a stray can be detected with an age group who is likely to become a stray as a stray candidate, speedup of stray detection can be achieved and an abducted stray can be promptly detected compared with the case of, for example, setting all persons as stray candidates without providing a condition related to age. Accordingly, safety of the stray can be ensured.

According to the first example embodiment, in a case where a companion of a stray candidate exists at the first point in time, the stray detection unit 134 detects a stray from among stray candidates, based on whether the companion of the stray candidate has changed between the first point in time and the second point in time.

Consequently, an abducted stray can be automatically detected, and therefore, an abducted stray can be promptly detected and measures such as rescue of the stray can be taken. Accordingly, safety of the stray can be ensured.

According to the first example embodiment, in a case where a companion of a stray candidate exists at the first point in time, the stray detection unit 134 detects a stray from among stray candidates, based on the comparison result and a degree of danger based on the position of the stray candidate at the first point in time.

Consequently, a stray with a high degree of danger can be detected. Accordingly, safety of the stray can be ensured.

According to the first example embodiment, the information processing system 100 further includes the grouping unit 133 that determines a group to which persons in a video belong by using person attributes included in an analysis result and the grouping condition for grouping persons captured in a video. In a case where a companion of a stray candidate exists at the first point in time, the stray detection unit 134 compares the companion of the stray candidate between the first point in time and the second point in time by using groups to which the stray candidate belongs at the first point in time and the second point in time, respectively, and detects a stray from among stray candidates, based on the comparison result.

Consequently, by grouping persons by using person attributes, a stray candidate having a companion at the second point in time can be easily detected. Therefore, an abducted stray can be automatically detected; and therefore, an abducted stray can be promptly detected and measures such as rescue of the stray can be taken. Accordingly, safety of the stray can be ensured.

According to the first example embodiment, the stray detection unit 134 includes the identification unit 134a and the stray determination unit 134c. The identification unit 134a identifies whether a companion of a stray candidate exists at the first point in time by using a group to which the stray candidate belongs at the first point in time. In a case where a companion of a stray candidate is identified to exist at the first point in time, the stray determination unit 134c compares a person belonging to the same group as the stray candidate at the first point in time with a person belonging to the same group as the stray candidate at the second point in time and detects a stray from among stray candidates, based on the comparison result.

Thus, by grouping persons by using person attributes, a stray candidate having a companion at the first point in time can be easily detected. A stray having a companion at the first point in time is highly likely an abducted stray; and since such a stray can be automatically detected, an abducted stray can be promptly detected and measures such as rescue of the stray can be taken. Accordingly, safety of the stray can be ensured.

According to the first example embodiment, the stray information includes at least one of an image of a detected stray and the position of the stray at the first point in time.

Consequently, a detected stray can be more easily found, and the stray can be promptly rescued. Accordingly, safety of the stray can be ensured.

According to the first example embodiment, in a case where there are a plurality of detected strays, the display control unit 135 causes the display unit 136 to display pieces of stray information of the plurality of strays in descending order of degree of danger at the first point in time.

Consequently, a stray with a high degree of danger can be more easily noticed. Accordingly, safety of the stray can be ensured.

### Second Example Embodiment

In general, a protector or the like being a companion of a stray may visit a stray center, a management center, or the like for inquiry about the stray. In such a case, a person concerned in a target area responding to the inquiry by the protector or the like may ask the protector about a feature of the stray. An example of an information processing system detecting an abducted stray by accepting a feature of such a stray and further referring to the feature information will be described in the present example embodiment.

Points different from the first example embodiment will be mainly described in the present example embodiment for simplification of description.

An information processing system according to the present example embodiment includes an information processing apparatus 203 in place of the information processing apparatus 103 according to the first example embodiment. Except for this point, the information processing system according to the present example embodiment is preferably configured similarly to the information processing system 100 according to the first example embodiment.

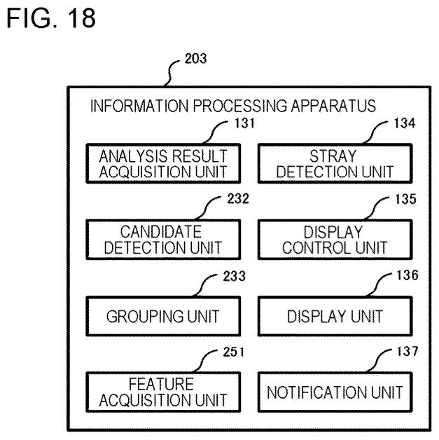

FIG. 18 is a diagram illustrating a functional configuration example of the information processing apparatus 203 according to the second example embodiment. The information processing apparatus 203 includes a candidate detection unit 232 and a grouping unit 233 in place of the candidate detection unit 132 and the grouping unit 133 according to the first example embodiment. The information processing apparatus 203 further includes a feature acquisition unit 251. Except for the above, the information processing apparatus 203 according to the present example embodiment is preferably configured similarly to the information processing apparatus 103 according to the first example embodiment.

The feature acquisition unit 251 acquires feature information of a stray being a detection target, based on a verbal input or the like of a user who knows a feature of the stray. The feature acquisition unit 251 may further acquire feature information of a person providing the feature information of the stray (a companion), based on a user input or the like. The feature information of the companion may include an image of the companion acquired by image capture of the companion by the user.

The candidate detection unit 232 detects a stray candidate from persons captured in videos by using person attributes included in an analysis result acquired by an analysis result acquisition unit 131 and a candidate condition, similarly to the candidate detection unit 132 according to the first example embodiment. The candidate condition according to the present example embodiment differs from that according to the first example embodiment in including feature information acquired by the feature acquisition unit 251.

The grouping unit 233 determines a group to which persons in a video belong by using person attributes included in an analysis result and a predetermined grouping condition, similarly to the grouping unit 133 according to the first example embodiment. The grouping unit 233 according to the present example embodiment determines a group to which persons in a video belong by further using feature information of a stray acquired by the feature acquisition unit 251.

More specifically, for example, the grouping unit 233 may determine a group to which persons in a video belong by using feature information of a stray and feature information of a companion. In this case, the grouping unit 233 determines that persons the person attributes of whom included in the analysis result are respectively similar to the feature information of the stray and the feature information of the companion belong to a common group.

“Being similar” herein refers to being similar to such a degree that a predetermined condition is satisfied and more specifically, for example, a degree of similarity being equal to or greater than a threshold value. Note that the grouping unit 233 may not use the grouping condition.

The information processing system according to the present example embodiment may be physically configured similarly to the information processing system 100 according to the first example embodiment.

### Operation of Information Processing System According to Second Example Embodiment

Information processing according to the present example embodiment includes image capture processing, analysis processing, and display processing that are similar to those according to the first example embodiment and stray detection processing different from that according to the first example embodiment. The stray detection processing is executed by the information processing apparatus 203 also in the present example embodiment.

### Example of Stray Detection Processing According to Second Example Embodiment

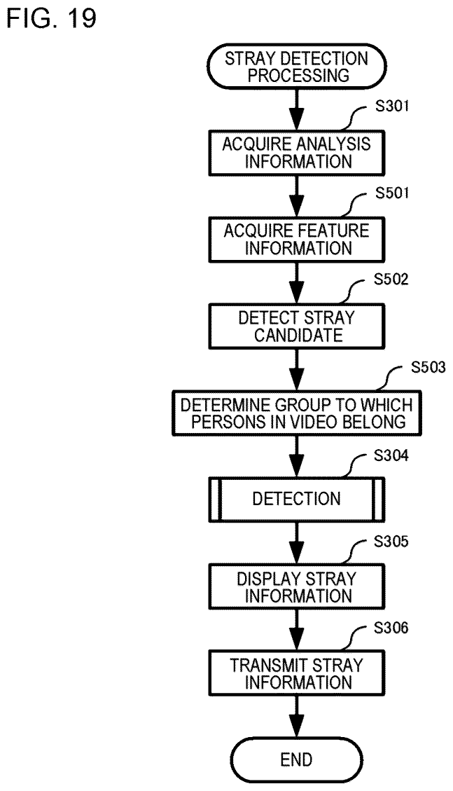

FIG. 19 is a flowchart illustrating an example of the stray detection processing according to the second example embodiment. As illustrated in the diagram, the stray detection processing according to the present example embodiment includes Step S501 executed subsequently to Step S302 similar to that according to the first example embodiment and Steps S502 and S503 replacing Steps S302 and S303 according to the first example embodiment. Except for the above, the stray detection processing according to the second example embodiment is preferably configured similarly to the stray detection processing according to the first example embodiment.

The feature acquisition unit 251 acquires feature information, based on a user input or the like (Step S501).

More specifically, for example, the feature acquisition unit 251 acquires feature information of a stray being a detection target and feature information of a companion of the stray, based on a user input or the like. The companion is a companion of the stray being the detection target and is, for example, a protector of the stray.

The candidate detection unit 232 detects a stray candidate from persons included in the analysis result by using person attributes included in the analysis result acquired in Step S301 and a candidate condition including the feature information of the stray acquired in Step S501 (Step S502).

More specifically, for example, the candidate detection unit 232 detects, as a stray candidate, a person associated with a person attribute satisfying the candidate condition out of the person attributes of the persons included in the analysis result acquired in Step S301. For example, a person attribute satisfying the candidate condition may be a person attribute similar to feature information included in the candidate condition.

The grouping unit 233 determines a group to which persons in the frame image acquired in Step S301 belong by using person attributes, a predetermined grouping condition, and the feature information acquired in Step S501 (Step S503).

The person attribute is a person attribute included in the analysis result acquired in Step S301. The feature information is the feature information acquired in Step S501 and, for example, the respective pieces of feature information of a stray and a companion.

More specifically, for example, for the persons included in the analysis result acquired in Step S301, the grouping unit 233 detects a plurality of persons associated with person attributes satisfying the grouping condition. The grouping unit 233 further detects and groups persons associated with person attributes similar to the respective pieces of feature information of the stray and the companion from among the plurality of detected persons.

In the case of a stray being abducted, the abduction can be detected by using verbally acquired feature information or the like of the stray, by executing the stray detection processing according to the present example embodiment.

### Advantageous Effect

As described above, according to the second example embodiment, the information processing system 100 further includes the feature acquisition unit 251 that acquires feature information of a stray being a detection target. The candidate condition includes the feature information of the stray.

Consequently, in a case where a stray is abducted, the stray can be detected by using the feature information of the stray. An abducted stray is generally in a dangerous situation; and therefore, the stray in such a dangerous situation can be promptly detected. Accordingly, safety of the stray can be ensured.

According to the second example embodiment, the information processing system 100 further includes the feature acquisition unit 251 that acquires feature information of a stray being a detection target. The grouping unit 233 determines a group to which persons in a video belong by further using the feature information of the stray.

Consequently, a group to which the stray belongs can be determined and a companion of the stray can be identified; and therefore, existence of a companion of the stray can be more reliably detected. Therefore, in a case where the stray is abducted, the abduction can be reliably detected. Accordingly, safety of the stray can be ensured.

### Third Example Embodiment

An example of predicting a moving range of a stray and utilizing the predicted moving range in a search range and stray information will be described in the present example embodiment. Note that a moving range may be utilized only in either of a search range and stray information.

Points different from the first example embodiment will be mainly described in the present example embodiment for simplification of description.

An information processing system according to the present example embodiment includes an information processing apparatus 303 in place of the information processing apparatus 103 according to the first example embodiment. Except for this point, the information processing system according to the present example embodiment is preferably configured similarly to the information processing system 100 according to the first example embodiment.

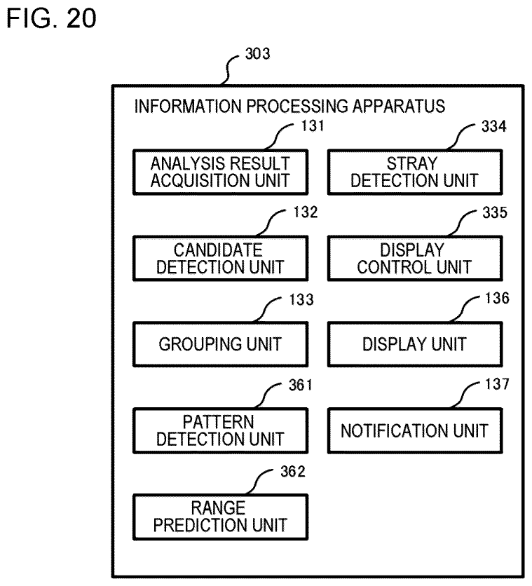

FIG. 20 is a diagram illustrating a functional configuration example of the information processing apparatus 303 according to the third example embodiment. The information processing apparatus 303 includes a stray detection unit 334 and a display control unit 335 in place of the stray detection unit 134 and the display control unit 135 according to the first example embodiment. The information processing apparatus 203 further includes a pattern detection unit 361 and a range prediction unit 362. Except for the above, the information processing apparatus 303 according to the present example embodiment is preferably configured similarly to the information processing apparatus 103 according to the first example embodiment.

The pattern detection unit 361 detects a moving pattern of a person captured in a video, based on person attributes between a first point in time and a second point in time.

A moving pattern is a tendency related to movement of a person and, for example, includes one or more of an average moving velocity, a moving velocity in front of a store, a time during which the person stops in front of a store, a type of store at which the person slows down or stops, a type of store at which the person drops in, and an average moving velocity in a store.

Examples of a person being a target of detection of a moving pattern include one or more of a detected stray, a stray candidate, a companion of a stray, and a companion of a stray candidate. Note that a person being a target of detection of a moving pattern is not limited to the above.

The range prediction unit 362 predicts a moving range of a person captured in a video by using a person attribute. The range prediction unit 362 preferably predicts a moving range of a person captured in a video by using, for example, at least one of the position, the moving direction, and the moving velocity of the person out of person attributes.

For example, the range prediction unit 362 may predict a moving range of a person captured in a video between a first point in time and a second point in time. In this case, for example, the range prediction unit 362 may predict a moving range of the person captured in the video between the first point in time and the second point in time by using a moving pattern detected by the pattern detection unit 361 in addition to a person attribute.

For example, the range prediction unit 362 may predict a moving range of a person after a first point in time. In a case where the first point in time is the present, a moving range after the first point in time is a future moving range. In this case, for example, the range prediction unit 362 preferably predicts a moving range of the person by using a person attribute (e.g., at least one of the position, the moving direction, and the moving velocity of a stray) at the first point in time.

Further, for example, the range prediction unit 362 may predict a moving range of the person by further using layout information. In this case, for example, the range prediction unit 362 may predict a moving range including movement of a person between floors, based on at least one item out of the positions of an escalator and an elevator that are included in the layout information, and the position, the moving direction, and the moving velocity of the person. The range prediction unit 362 may previously hold the layout information.

Examples of a person being a target of prediction of a moving range include one or more of a detected stray, a stray candidate, a companion of a stray, and a companion of a stray candidate. Note that a person being a target of detection of a moving pattern is not limited to the above.

The stray detection unit 334 detects a stray from among stray candidates and generates stray information related to the detected stray, similarly to the stray detection unit 134 according to the first example embodiment.

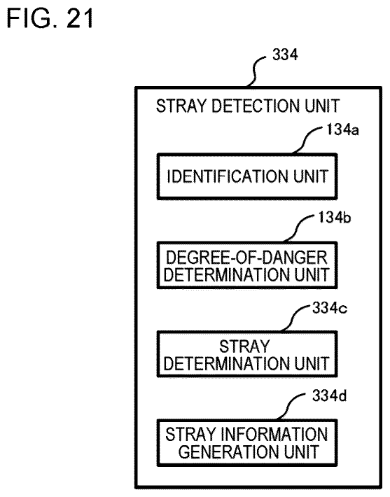

FIG. 21 is a diagram illustrating a functional configuration example of the stray detection unit 334 according to the third example embodiment. The stray detection unit 334 includes a stray determination unit 334c and a stray information generation unit 334d in place of the stray determination unit 134c and the stray information generation unit 134d according to the first example embodiment. Except for this point, the stray detection unit 334 is preferably configured similarly to the stray detection unit 134 according to the first example embodiment.

The stray determination unit 334c detects a stray from among stray candidates, based on a comparison result between a companion of the stray candidate at a first point in time and a companion of the stray candidate at a second point in time, similarly to the stray determination unit 134c according to the first example embodiment.

The stray determination unit 334c according to the present example embodiment sets a moving range predicted for a person by the range prediction unit 362 as a search range of the person and detects a stray candidate from persons captured in the search range.

The stray information generation unit 334d generates stray information related to a stray detected by the stray determination unit 134c, similarly to the stray information generation unit 134d according to the first example embodiment.

The stray information according to the present example embodiment may include a moving range predicted for a stray by the range prediction unit 362. In this case, for example, the stray information preferably includes a moving range after a first point in time at which the range prediction unit 362 has made the prediction for the stray.

FIG. 20 is referred to again.

The display control unit 335 causes a display unit 136 to display various types of information, similarly to the display control unit 135 according to the first example embodiment. For example, the display control unit 335 may cause the display unit 136 to display stray information generated by the stray detection unit 134 (more specifically, the stray information generation unit 134d).

The stray information according to the present example embodiment may further include layout information. In this case, for example, the display control unit 335 may cause the display unit 136 to display an image acquired by superposing a moving range predicted for a stray by the range prediction unit 362 on the layout information.

For example, the display control unit 335 may cause the display unit 136 to display an image acquired by superposing the position of a stray at a first point in time on the layout information. For example, the display control unit 135 may cause the display unit 136 to display an image acquired by superposing the position of a stray at a second point in time on the layout information.

The information processing system according to the present example embodiment may be physically configured similarly to the information processing system 100 according to the first example embodiment.

### Operation of Information Processing System According to Third Example Embodiment

Information processing according to the present example embodiment includes image capture processing, analysis processing, and display processing that are similar to those according to the first example embodiment and stray detection processing different from that according to the first example embodiment. The stray detection processing is executed by the information processing apparatus 303 also in the present example embodiment.

### Example of Stray Detection Processing According to Third Example Embodiment

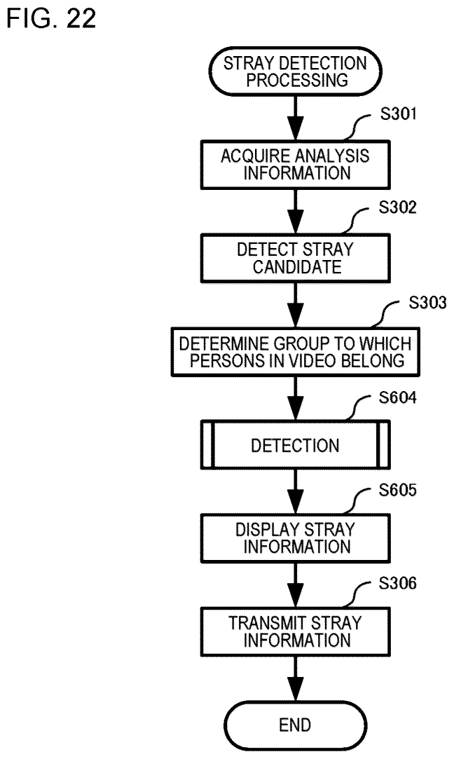

FIG. 22 is a flowchart illustrating an example of the stray detection processing according to the third example embodiment. As illustrated in the diagram, the stray detection processing according to the present example embodiment includes Steps S604 and S605 replacing Steps S304 and S305 according to the first example embodiment. Except for the above, the stray detection processing according to the third example embodiment is preferably configured similarly to the stray detection processing according to the first example embodiment.

The stray detection unit 334 detects a stray from among stray candidates detected in Step S302, similarly to the stray detection unit 134 according to the first example embodiment (Step S604). Details of detection processing in the present example embodiment (Step S604) are different from the detection processing according to the first example embodiment (Step S304).

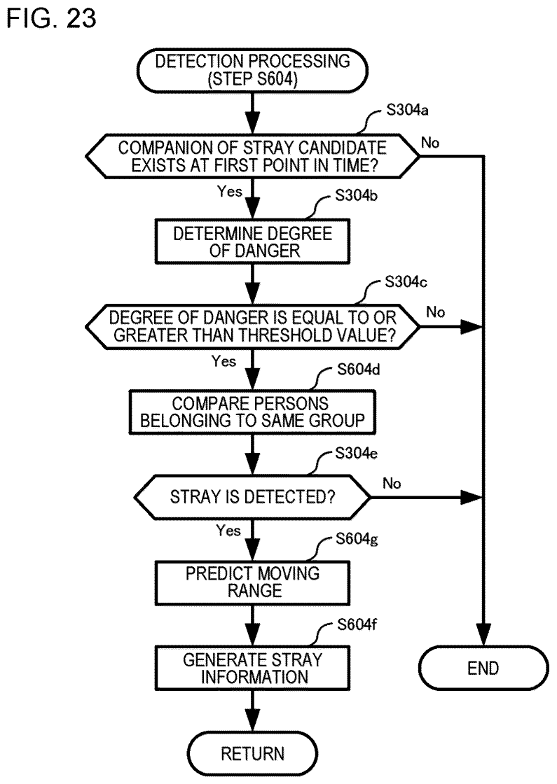

FIG. 23 is a flowchart illustrating an example of the detection processing according to the third example embodiment (Step S604). The detection processing according to the present example embodiment (Step S604) includes Steps S604d and S604f replacing Steps S304d and S304f according to the first example embodiment. The detection processing according to the present example embodiment (Step S604) further includes Step S604g executed between Steps S304e and S604f. Except for the above, the detection processing according to the present example embodiment (Step S604) may be configured similarly to the detection processing according to the first example embodiment (Step S304).

In a case where a degree of danger is identified to be equal to or greater than a threshold value (Step S304c: Yes), the stray determination unit 334c compares a person belonging to the same group as a stray candidate at a first point in time with a person belonging to the same group as the stray candidate at a second point in time, similarly to the first example embodiment (Step S604d). Details of comparison processing in the present example embodiment (Step S604d) are different from the comparison processing according to the first example embodiment (Step S304d).

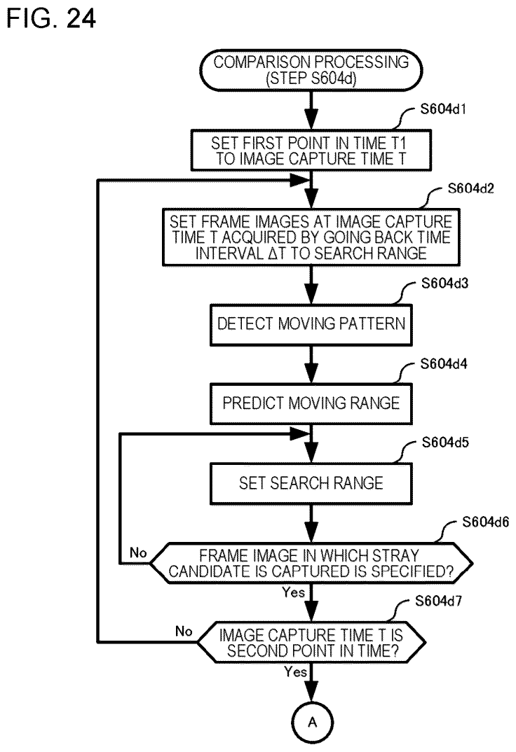

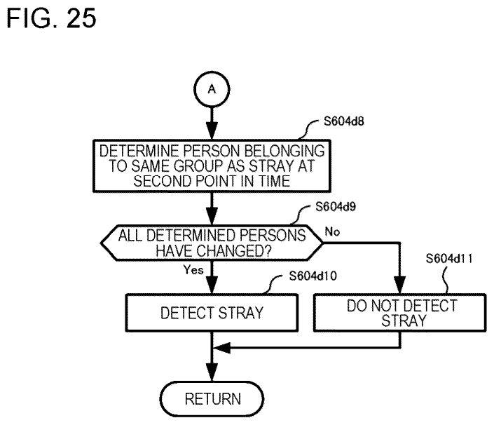

FIGS. 24 and 25 are flowcharts illustrating an example of the comparison processing according to the third example embodiment (Step S604d).

The stray determination unit 334c sets a time T1 of a first point in time to an image capture time T (Step S604d1). For example, the first point in time is the present, similarly to the first example embodiment.

The stray determination unit 334c sets frame images at an image capture time T acquired by going back a time interval ΔT to a search target (Step S604d2).

For example, in a case where the time T1 being the first point in time is set to the image capture time T, the stray determination unit 334c sets frame images at an image capture time T1-ΔT to the search target.

The pattern detection unit 361 detects a moving pattern of a stray candidate, based on person attributes included in an analysis result (Step S604d3).

For example, an analysis result generated based on frame images with image capture times from the first point in time to the image capture time of the frame images being the search target is used for detection of a moving pattern of the stray candidate in Step S604d3.

The range prediction unit 362 predicts a moving range of the stray candidate by using the person attribute of the stray candidate and the moving pattern detected in Step S604d3 (Step S604d4).

The stray determination unit 334c sets a search range to part or the whole of the frame images being the search target, based on the moving range predicted in Step S604d4 (Step S604d5).

More specifically, for example, the stray determination unit 334c sets frame images including the moving range predicted in Step S604d4 out of the frame images being the search target to a search range.

The stray determination unit 334c identifies whether a frame image in which the stray candidate is captured is determined from the search range set in Step S604d5 (Step S604d6).

More specifically, for example, the stray determination unit 334c searches the frame images being the search range for a frame image in which the stray candidate is captured. In a case where a frame image in which the stray candidate is captured is detected, the stray determination unit 334c identifies that a frame image in which the stray candidate is captured is determined. In a case where a frame image in which the stray candidate is captured is not detected, the stray determination unit 334c identifies that a frame image in which the stray candidate is captured is not determined.

In a case of identifying that a frame image in which the stray candidate is captured is not determined (Step S604d6: No), the stray determination unit 334c returns to Step S604d5. In re-executed Step S604d5, for example, the stray determination unit 334c preferably sets a frame image in which a region adjoining a region captured in the search range set in immediately preceding Step S604d5 is captured to a search range.

The stray determination unit 334c identifies whether the image capture time T is a second point in time (Step S604d7).

In a case of identifying the image capture time T to be not the second point in time (Step S604d7: No), the stray determination unit 334c returns to Step S604d2.

FIG. 25 is referred to.

In a case of identifying the image capture time T to be the second point in time (Step S604d7: Yes), the stray determination unit 334c determines a person belonging to the same group as the stray candidate at the second point in time (Step S604d8).

More specifically, for example, the stray determination unit 334c determines a person belonging to the same group as the stray candidate (i.e., a companion of the stray candidate), the person being determined by using an analysis result based on the frame image determined in S604d6, and a grouping condition.

The stray determination unit 334c identifies whether all persons identified to be companions of the stray candidate have changed between the first point in time and the second point in time (Step S604d9).

More specifically, for example, the stray determination unit 334c acquires person attributes of persons identified to be companions of the stray candidate at the first point in time in Step S304a. The stray determination unit 334c acquires person attributes of persons determined to be companions of the stray candidate at the second point in time in Step S604d8.

By comparing the person attributes of the companions of the stray candidate between the first point in time and the second point in time, the stray determination unit 334c identifies whether all the companions of the stray candidate have changed between the first point in time and the second point in time. For example, in a case where a degree of similarity in the person attribute of every companion of the stray candidate between the first point in time and the second point in time is less than a predetermined threshold value, the stray determination unit 334c identifies that all the companions have changed. Further, for example, in a case where a degree of similarity in the person attribute of at least one companion of the stray candidate between the first point in time and the second point in time is equal to or greater than the predetermined threshold value, the stray determination unit 334c identifies that not all the companions have changed.

In a case of identifying that all the companions have changed (Step S604d9: Yes), the stray determination unit 334c detects a stray (Step S604d10) and returns to the detection processing (Step S604). In other words, the stray candidate is detected as a stray in this case.

In a case of identifying that not all the companions have changed (Step S604d9: No), the stray determination unit 334c does not detect a stray (Step S604d11) and returns to the detection processing (Step S604). In other words, the stray candidate is handled as not being a stray in this case.

FIG. 23 is referred to again.

In a case where a stray is detected in Step S304e similar to that according to the first example embodiment (Step S304e: Yes), the range prediction unit 362 predicts a future moving range of the stray, based on the person attribute of the stray detected in Step S304e (Step S604g).

The stray information generation unit 134d generates stray information related to the stray (Step S604f) and returns to the stray detection processing. For example, the stray information generated here includes the moving range generated in Step S604g and the layout information.

FIG. 22 is referred to again.

The display control unit 335 causes the display unit 136 to display the stray information generated in Step S604f (Step S605). For example, the display control unit 335 causes the display unit 136 to display a screen acquired by superposing the future moving range predicted for the stray on the layout information.

In such stray detection processing, a search range can be narrowed down from among frame images, based on a predicted moving range for a stray candidate. Therefore, the processing load in the comparison processing can be lightened.

Further, the future moving range predicted for the stray can be displayed by the display unit 136. Consequently, an abducted stray can be more easily found, and the possibility of promptly finding the stray can be increased.

### Advantageous Effect

As described above, according to the third example embodiment, the information processing system further includes the range prediction unit 362 that predicts a moving range of a person captured in a video by using a person attribute.

Consequently, by detecting a stray by predicting a moving range of a stray candidate, the processing load can be lightened, and speedup of stray detection can be achieved. Further, since a search for the detected stray can be performed by referring to a moving range of the stray, rescue of the stray can be facilitated. Accordingly, safety of the stray can be ensured.

According to the third example embodiment, the range prediction unit 362 predicts a moving range of a person by further using layout information about locations images of which are captured by a plurality of image capture apparatuses 101.

Consequently, prediction of a moving range can be improved. Therefore, yet further speedup of stray detection can be achieved, and rescue of a stray can be further facilitated. Accordingly, safety of the stray can be ensured.

According to the third example embodiment, the information processing system further includes the pattern detection unit 361 that detects a moving pattern of a person captured in a video, based on person attributes between a first point in time and a second point in time. The range prediction unit 362 predicts a moving range of a person captured in a video between the first point in time and the second point in time by further using a moving pattern.

Consequently, prediction of a moving range can be improved. Therefore, yet further speedup of stray detection can be achieved, and rescue of a stray can be further facilitated. Accordingly, safety of the stray can be ensured.

According to the third example embodiment, the stray detection unit 334 sets a moving range predicted for a stray candidate as a search range of the stray candidate and detects the stray candidate from persons captured in the search range.

Consequently, by detecting a stray by predicting a moving range of a stray candidate, the processing load can be lightened, and speedup of stray detection can be achieved. Accordingly, safety of the stray can be ensured.

According to the third example embodiment, the information processing system further includes the display control unit 335 that causes the display unit 136 to display stray information related to a detected stray. The range prediction unit 362 predicts a moving range of the detected stray. The stray information includes the predicted moving range.

Consequently, a search for the detected stray can be performed by referring to the moving range of the stray, and therefore, rescue of the stray can be facilitated. Accordingly, safety of the stray can be ensured.

According to the third example embodiment, stray information further includes layout information. The display control unit 335 causes the display unit 136 to display an image acquired by superposing a predicted moving range on the layout information.

Consequently, a search for a detected stray can be easily performed by referring to a moving range of the stray, and therefore, rescue of the stray can be still further facilitated. Accordingly, safety of the stray can be ensured.

While the example embodiments of the present invention and the modified examples thereof have been described above with reference to the drawings, the example embodiments and the modified examples are examples of the present invention, and various configurations other than those described above may also be employed.

Further, while a plurality of processes (processing) are described in a sequential order in each of a plurality of flowcharts used in the aforementioned description, the execution order of processes executed in each example embodiment is not limited to the order of description. The order of the illustrated processes may be modified in each example embodiment without affecting the contents. Further, the aforementioned example embodiments may be combined without contradicting each other.

The whole or part of the example embodiments disclosed above may also be described as, but not limited to, the following supplementary notes.
1. An information processing system including:
   an analysis result acquisition unit that acquires an analysis result of videos captured by a plurality of image capture units;
   a candidate detection unit that detects a stray candidate from one or more persons captured in the video by using one or more person attributes included in the analysis result and a candidate condition; and
   a stray detection unit that, in a case where a companion of the stray candidate exists at a first point in time, detects a stray from among the one or more stray candidates, based on a comparison result between a companion of the stray candidate at the first point in time and a companion of the stray candidate at a second point in time earlier than the first point in time.
2. The information processing system according to supplementary note 1, wherein
   the candidate condition includes a condition related to age.
3. The information processing system according to supplementary note 1 or 2, further including
   a feature acquisition unit that acquires feature information of a stray being a detection target, wherein
   the candidate condition includes feature information of the stray.
4. The information processing system according to any one of supplementary notes 1 to 3, wherein,
   in a case where a companion of the stray candidate exists at a first point in time, the stray detection unit detects a stray from among the one or more stray candidates, based on whether a companion of the stray candidate has changed between the first point in time and the second point in time.
5. The information processing system according to any one of supplementary notes 1 to 4, wherein,
   in a case where a companion of the stray candidate exists at a first point in time, the stray detection unit detects a stray from among the one or more stray candidates, based on the comparison result and a degree of danger based on a position of the stray candidate at a first point in time.
6. The information processing system according to any one of supplementary notes 1 to 5, further including
   a grouping unit that determines a group to which a person in the video belongs by using a person attribute included in the analysis result and a grouping condition for grouping one or more persons captured in the video, wherein,
   in a case where a companion of the stray candidate exists at a first point in time, the stray detection unit compares a companion of the stray candidate between the first point in time and the second point in time by using groups to which the stray candidate belongs at the first point in time and the second point in time, respectively, and detects a stray from among the one or more stray candidates, based on the comparison result.
7. The information processing system according to supplementary note 6, wherein
   the stray detection unit includes:
      an identification unit that identifies whether a companion of the stray candidate exists at the first point in time by using a group to which the stray candidate belongs at the first point in time; and
      a stray determination unit that, in a case where a companion of the stray candidate is identified to exist at the first point in time, compares a person belonging to a same group as the stray candidate between the first point in time and the second point in time and detects a stray from among the one or more stray candidates, based on the comparison result.
8. The information processing system according to supplementary note 6 or 7, further including
   a feature acquisition unit that acquires feature information of a stray being a detection target, wherein
   a grouping unit determines a group to which a person in the video belongs by further using feature information of the stray.
9. The information processing system according to any one of supplementary notes 1 to 8, further including
   a range prediction unit that predicts a moving range of a person captured in the video by using the person attribute.
10. The information processing system according to supplementary note 9, wherein
   the range prediction unit predicts a moving range of the person by further using layout information about a location images of which are captured by the plurality of image capture units.
11. The information processing system according to supplementary note 9 or 10, further including
   a pattern detection unit that detects a moving pattern of a person captured in the video, based on a person attribute between the first point in time and the second point in time, wherein
   the range prediction unit predicts a moving range of a person captured in the video between the first point in time and the second point in time by further using the moving pattern.
12. The information processing system according to supplementary note 11, wherein
   the stray detection unit sets a moving range predicted for the stray candidate as a search range of the stray candidate and detects a stray candidate from one or more persons captured in the search range.
13. The information processing system according to any one of supplementary notes 9 to 12, further including
   a display control unit that causes a display unit to display stray information related to the detected stray, wherein
   the range prediction unit predicts a moving range of the detected stray, and
   the stray information includes the predicted moving range.
14. The information processing system according to supplementary note 13, wherein
   the stray information further includes the layout information, and
   the display control unit causes the display unit to display an image acquired by superposing the predicted moving range on the layout information.
15. The information processing system according to supplementary note 13 or 14, wherein
   the stray information includes at least one of an image of the detected stray and a position of the detected stray at the first point in time.
16. The information processing system according to any one of supplementary notes 13 to 15, wherein,
   in a case where there are a plurality of the detected strays, the display control unit causes the display unit to display pieces of the stray information of the plurality of strays in descending order of degree of danger at the first point in time.
17. An information processing apparatus including:
   an analysis result acquisition unit that acquires an analysis result of videos captured by a plurality of image capture units;
   a candidate detection unit that detects a stray candidate from one or more persons captured in the video by using one or more person attributes included in the analysis result and a candidate condition; and
   a stray detection unit that, in a case where a companion of the stray candidate exists at a first point in time, detects a stray from among the one or more stray candidates, based on a comparison result between a companion of the stray candidate at the first point in time and a companion of the stray candidate at a second point in time earlier than the first point in time.
18. An information processing method including, by one or more computers:
   acquiring an analysis result of videos captured by a plurality of image capture units;
   detecting a stray candidate from one or more persons captured in the video by using one or more person attributes included in the analysis result and a candidate condition; and,
   in a case where a companion of the stray candidate exists at a first point in time, detecting a stray from among the one or more stray candidates, based on a comparison result between a companion of the stray candidate at the first point in time and a companion of the stray candidate at a second point in time earlier than the first point in time.
19. A medium on which a program is recorded, the program causing one or more computers to execute:
   acquiring an analysis result of videos captured by a plurality of image capture units;
   detecting a stray candidate from one or more persons captured in the video by using one or more person attributes included in the analysis result and a candidate condition; and,
   in a case where a companion of the stray candidate exists at a first point in time, detecting a stray from among the one or more stray candidates, based on a comparison result between a companion of the stray candidate at the first point in time and a companion of the stray candidate at a second point in time earlier than the first point in time.

### REFERENCE SIGNS LIST

100 Information processing system
101, 101_1 to 101_M1 Image capture apparatus
102 Analysis apparatus
103, 203, 303 Information processing apparatus
104, 104_1 to 104_M2 Terminal
131 Analysis result acquisition unit
132, 232 Candidate detection unit
133, 233 Grouping unit
134, 334 Stray detection unit
134a Identification unit
134b Degree-of-danger determination unit
134c, 334c Stray determination unit
134d, 334d Stray information generation unit
135, 335 Display control unit
136 Display unit
137 Notification unit
141 Stray information acquisition unit
142 Display control unit
143 Display unit
251 Feature acquisition unit
361 Pattern detection unit
362 Range prediction unit

What is claimed is:

1. An information processing system comprising:
at least one memory storing instructions; and
at least one processor configured to:
acquire an analysis result of videos captured by a plurality of image capture units;
detect a stray candidate from one or more persons captured in the video by using one or more person attributes included in the analysis result and a candidate condition; and
in a case where a companion of the stray candidate exists at a first point in time, detect a stray from among the one or more stray candidates, based on a comparison result between a companion of the stray candidate at the first point in time and a companion of the stray candidate at a second point in time earlier than the first point in time.

2. The information processing system according to claim 1, wherein
the candidate condition includes a condition related to age.

3. The information processing system according to claim 1, wherein the at least one processor is further configured to
acquire feature information of a stray being a detection target, wherein
the candidate condition includes feature information of the stray.

4. The information processing system according to claim 1, wherein the at least one processor is configured to,
in a case where a companion of the stray candidate exists at a first point in time, detect a stray from among the one or more stray candidates, based on whether a companion of the stray candidate has changed between the first point in time and the second point in time.

5. The information processing system according to claim 1, wherein the at least one processor is configured to,
in a case where a companion of the stray candidate exists at a first point in time, detect a stray from among the one or more stray candidates, based on the comparison result and a degree of danger based on a position of the stray candidate at a first point in time.

6. The information processing system according to claim 1, the at least one processor is further configured to
determine a group to which a person in the video belongs by using a person attribute included in the analysis result and a grouping condition for grouping one or more persons captured in the video;
in a case where a companion of the stray candidate exists at a first point in time, compare a companion of the stray candidate between the first point in time and the second point in time by using groups to which the stray candidate belongs at the first point in time and the second point in time, respectively; and
detect a stray from among the one or more stray candidates, based on the comparison result.

7. The information processing system according to claim 6, wherein the at least one processor is further configured to:
identify whether a companion of the stray candidate exists at the first point in time by using a group to which the stray candidate belongs at the first point in time; and
in a case where a companion of the stray candidate is identified to exist at the first point in time, compare a person belonging to a same group as the stray candidate between the first point in time and the second point in time and detects a stray from among the one or more stray candidates, based on the comparison result.

8. The information processing system according to claim 6, wherein the at least one processor is further configured to
acquire feature information of a stray being a detection target; and
determine a group to which a person in the video belongs by further using feature information of the stray.

9. The information processing system according to claim 1, wherein the at least one processor is further configured to
predict a moving range of a person captured in the video by using the person attribute.

10. The information processing system according to claim 9, wherein the at least one processor is configured to
predict a moving range of the person by further using layout information about a location images of which are captured by the plurality of image capture units.

11. The information processing system according to claim 9, wherein the at least one processor is further configured to:
detect a moving pattern of a person captured in the video, based on a person attribute between the first point in time and the second point in time, and
predict a moving range of a person captured in the video between the first point in time and the second point in time by further using the moving pattern.

12. The information processing system according to claim 11, wherein the at least one processor is configured to:
set a moving range predicted for the stray candidate as a search range of the stray candidate; and
detect a stray candidate from one or more persons captured in the search range.

13. The information processing system according to claim 9, wherein the at least one processor is further configured to:
cause a display unit to display stray information related to the detected stray; and
predict a moving range of the detected stray, and
the stray information includes the predicted moving range.

14. The information processing system according to claim 13, wherein
the stray information further includes the layout information, and the at least one processor is configured to
cause the display unit to display an image acquired by superposing the predicted moving range on the layout information.

15. The information processing system according to claim 13, wherein
the stray information includes at least one of an image of the detected stray and a position of the detected stray at the first point in time.

16. The information processing system according to claim 13, wherein the at least one processor is configured to,
in a case where there are a plurality of the detected strays, cause the display unit to display pieces of the stray information of the plurality of strays in descending order of degree of danger at the first point in time.

17. (canceled)

18. An information processing method comprising, by one or more computers:
acquiring an analysis result of videos captured by a plurality of image capture units;
detecting a stray candidate from one or more persons captured in the video by using one or more person attributes included in the analysis result and a candidate condition; and,
in a case where a companion of the stray candidate exists at a first point in time, detecting a stray from among the one or more stray candidates, based on a comparison result between a companion of the stray candidate at the first point in time and a companion of the stray candidate at a second point in time earlier than the first point in time.

19. A non-transitory computer-readable medium storing an information processing program that causes one or more computers to execute:
acquiring an analysis result of videos captured by a plurality of image capture units;
detecting a stray candidate from one or more persons captured in the video by using one or more person attributes included in the analysis result and a candidate condition; and,
in a case where a companion of the stray candidate exists at a first point in time, detecting a stray from among the one or more stray candidates, based on a comparison result between a companion of the stray candidate at the first point in time and a companion of the stray candidate at a second point in time earlier than the first point in time.
